(19) United States
(12) Patent Application Publication
(10) Pub. No.: US 2012/0056799 A1
(43) Pub. Date: Mar. 8, 2012

(54) Performance Audience Display System

(76) Inventor: Dennis Solomon, Yarmouth Port, MA (US)

(21) Appl. No.: 13/294,011

(22) Filed: Nov. 10, 2011

Related U.S. Application Data
(63) Continuation-in-part of application No. 12/456,401, filed on Jun. 15, 2009.
Application No. 12/456,401 is a continuation-in-part of application No. 11/358,847, filed on Feb. 18, 2006.
Application No. 11/358,847 is a continuation-in-part of application No. 11/149,638, filed on Jun. 9, 2005, now abandoned.
Application No. 11/149,638 is a continuation-in-part of application No. 10/941,461, filed on Sep. 15, 2004, now abandoned.
Application No. 10/941,461 is a continuation-in-part of application No. 10/385,349, filed on Mar. 10, 2003, now abandoned.
Application No. 10/385,349 is a continuation-in-part of application No. 10/307,620, filed on Dec. 2, 2002, now abandoned.
Application No. 10/307,620 is a continuation-in-part of application No. 10/172,629, filed on Jun. 14, 2002, now abandoned.
Application No. 10/172,629 is a continuation-in-part of application No. 09/793,811, filed on Feb. 24, 2001, now abandoned.
(60) Provisional application No. 61/460,808, filed on Jan. 7, 2011.

(51) Int. Cl. G09G 3/20

(52) U.S. Cl. 345/55

(57) ABSTRACT

An improved method and device for entertainment and the display of images incorporating the audience in a performance including the integration of independent, mobile three-dimensional audience display elements. Improved methods for manufacturing an integrated visual display incorporating scanned light sources in the audience display elements.

This present application claims the benefit and is a continuation-in-part of U.S. patent continuation-in-part application Ser. Nos. 12/456,401, 11/358,847, 11/149,638; 10/941,461; 10/385,349; 10/307,620; 10/172,629; 09/793,811; and of provisional patent applications 61/460,808, 60/212,315 and 60/558,258 which are incorporated herein in their entirety by reference.

### TECHNICAL FIELD

This invention relates generally to performance display devices and more particularly to multi-phasic imaging displays.

### BACKGROUND ART

The engagement of the audience in a display environment has been the goal of inventors since the origins of art. Significant advances in the displays have been accomplished including cycloramas, integral photography, and holography. Audience participation, as an active part of the environment special effect has never been perfected, and display systems which function independently and in concert, have not been substantially developed until the disclosure of my special effects display device in the parent U.S. patent application Ser. No. 09/250,384, now U.S. Pat. No. 6,404,409. A few inventions have been proposed which have generally been too complicated to be reliable, expensive to manufacture, without sufficient resolution, or sufficient stability to gain any acceptance. None have combined a directional projector and an active, responsive display unit which may be in the control of each member of the audience or used independently.

One technological approach—the presentation of visual images by moving display elements—has a long and crowded history. Following the development of light emitting diodes (LEDs), a large variety of displays, games, audience units and yo-yos have been manufactured, publicly presented and patented. These inventions strobe arrays of individual light elements or pixels as the array is displaced cyclically, producing an image or pattern due to the persistence phenomenon of human vision. Francis Duffy in his U.S. Pat. No. 3,958,235 discloses linear audience unit of LEDs oscillated by a door buzzer electromagnetic actuator. He specifically indicated that a manual actuator may be used. Edwin Berlin in his U.S. Pat. No. 4,160,973 extended the work of Duffy to both 2D & 3D devices using “rotational” or “short-distance oscillatory motion” with extensions of Nipkow's disc television. Berlin also disclosed the use of moving digital memory and electronics and a “single pulse (per cycle) which adjusts the frequency of a clock (controlling the timing of each LED)”. Bill Bell is his U.S. Pat. No. 4,470,044 disclosed a single stationary array of LEDs with “saccadic eye movement” timing with non-claimed references to applications including audience units, tops and bicycles.

Marhan Reysman in his U.S. Pat. No. 4,552,542 discloses a spinning disc toy with a centrifugal switch causing a light to be illuminated. It follows a line of inventions related to tops and yo-yos. Hiner is his U.S. Pat. No. 4,080,753 discloses a toy flying saucer with a centrifugal motion sensor.

The techniques of Duffy, Berlin & Bell were applied to handheld audience units differentiated from the prior art by the detailed centrifugal switch design. Tokimoto is his U.S. Pat. No. 5,406,300 discloses a audience unit with a Hall effect acceleration sensor. Sako in his U.S. Pat. No. 5,444,456 uses an inertial sensor having “a pair of fixed contacts and a moveable contact” to adjust the clock of the display electronics. While inventive and functional, the Sako design remains awkward and requires considerable energy to maintain an image. For these reasons, it is unsuitable for entertainment, marketing and game applications.

At many events from the mid-1980s, these and simpler visual and audio producing items have been combined with non-directional, wireless signals to produce a global special effects. As disclosed in Bell's U.S. Pat. No. 4,470,044, these technologies may be affixed to bicycles and motorized vehicles, to clothing, audience units, yo-yos and other accessories.

Additionally, wireless technologies have been applied to visual and audio producing proximity devices such as dance floors—U.S. Pat. No. 5,558,654, pagers—U.S. Pat. No. 3,865,001, top hats—U.S. Pat. No. 3,749,810, and clothing—U.S. Pat. No. 5,461,188 to produce a global synchrony and pre-programmed or transferred effects.

None of these or the other prior art has successfully addressed the problem of providing low cost, real-time, precision control of audio or visual effects such that an affordable uniform appliance distributed, affixed, attached, accompanying or held by each member of an audience or group would seamlessly, and without error, integrate in a global screen or orchestra in real-time.

None of the prior inventions was capable of independent and concerted three-dimensional visual effects. None permitted the simultaneous registration of all units. Further, a number of other problems have remained including the development of switching methodology which permits a static on-off state, display freedom from inertial changes, a frame of reference and global orientation.

This inventor has a long history of invention in these relative fields of persistence of vision, three dimensional and professional stage, film and event special effects. His U.S. Pat. No. 4,983,031 (1990) discloses a method of data display control and method for the proper display of images to all observers in both directions for projection and LED moving displays—technologies chosen by the U.S. Department of Defense for advanced airspace control. His U.S. Pat. Nos. 4,777,568 (1988) and 4,729,071 (1987) disclose a high speed, low inertial stage scanning system—currently in use by major international touring music and theatre acts. Further background audience display systems are also described in the my parent U.S. Pat. No. 6,404,409.

### SUMMARY OF THE INVENTION

The present invention discloses an improved and versatile performance display systems which includes a method and device for the low cost, real-time, precision control of audio or visual effects such that an affordable uniform appliance distributed, affixed, attached, accompanying or held by each member of an audience or group would seamlessly, and without error, integrate in a global screen or orchestra in real-time.

Additionally, an object of the invention is an improved motion switching method for the audience unit including a frame of reference to global orientation.

Another object of the invention is a reduction in the cost and energy required to operate the performance audience unit system.

A further object is the application of the invention to independent displays for all purposes.

The above and still further objects, features and advantages of the present invention will become apparent upon consideration of the following detailed disclosure of specific embodiments of the invention, especially when taken in conjunction with the accompanying drawings, wherein:

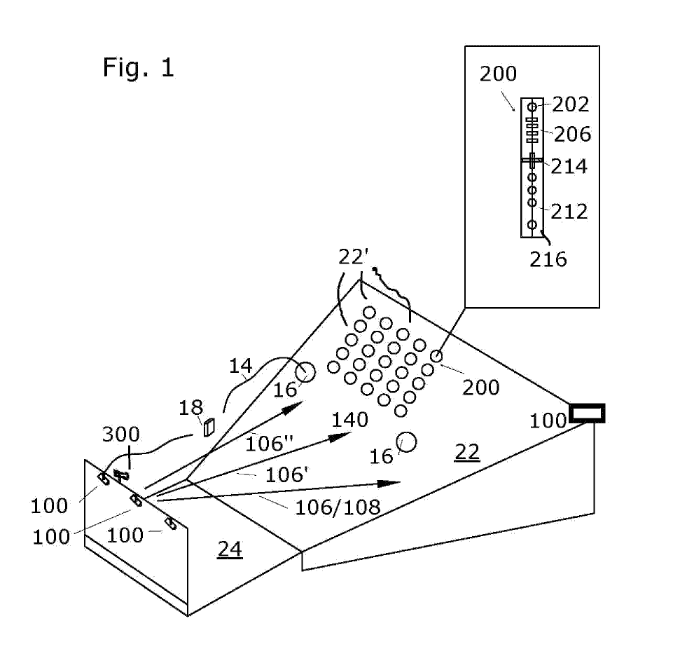

FIG. 1 presents a perspective view of the generalized performance display system.

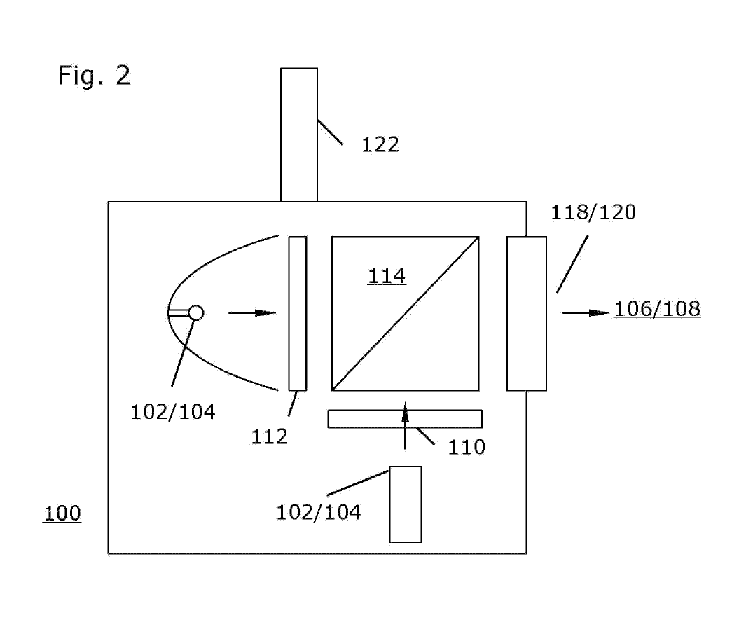

FIG. 2 presents a side view of a generalized data and image projector.

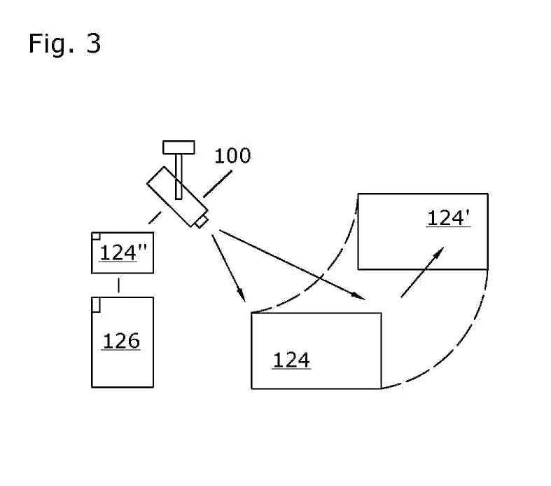

FIG. 3 presents a scanning projection correction method.

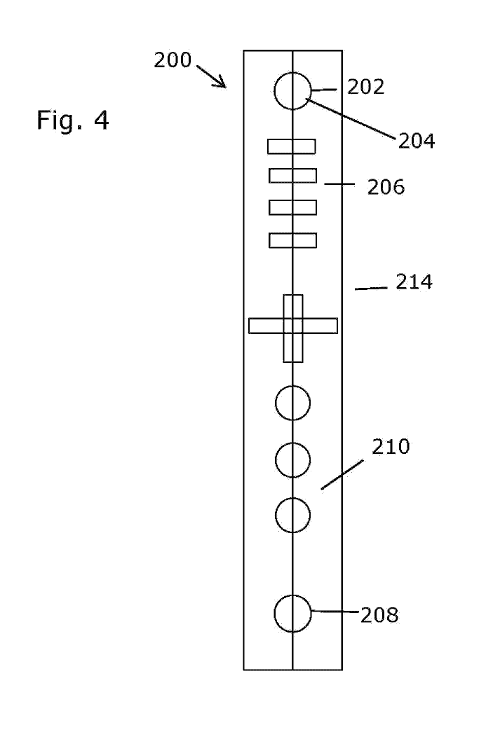

FIG. 4 presents a front view of a generalized audience unit.

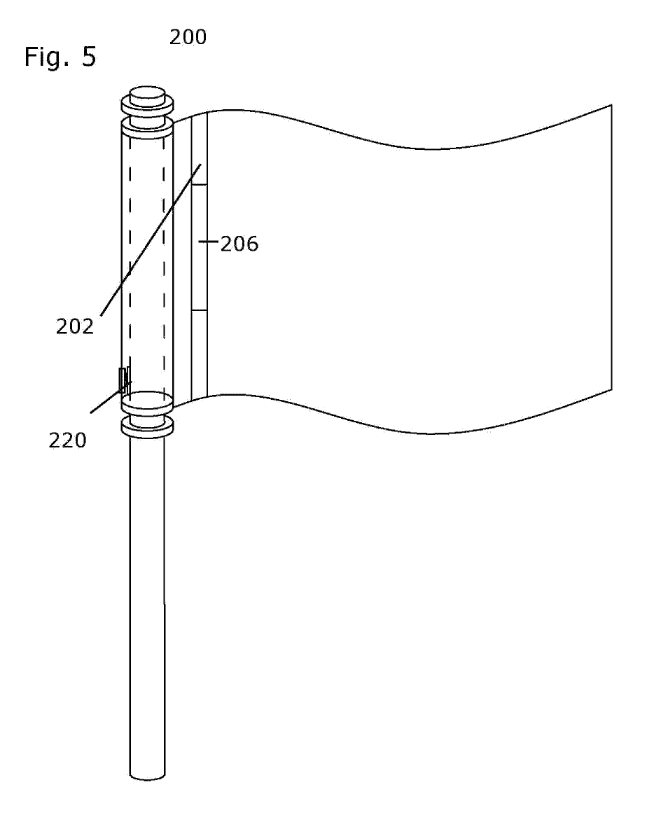

FIG. 5 presents a perspective view of a generalized banner audience unit.

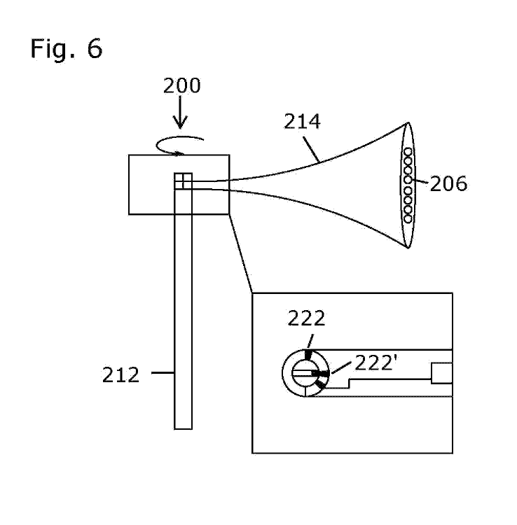

FIG. 6 presents a perspective view of a generalized spinner audience unit.

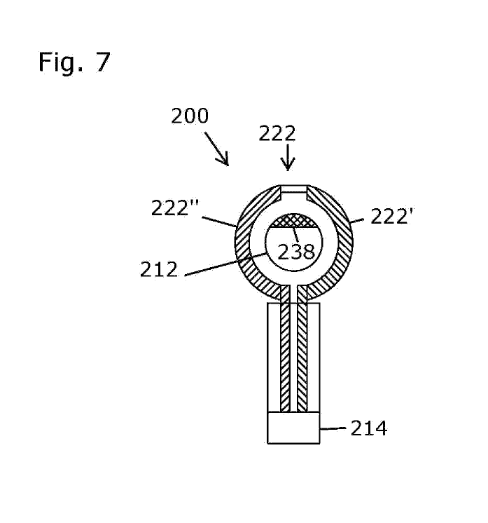

FIG. 7 presents a top view of a generalized snap attachment for the audience unit.

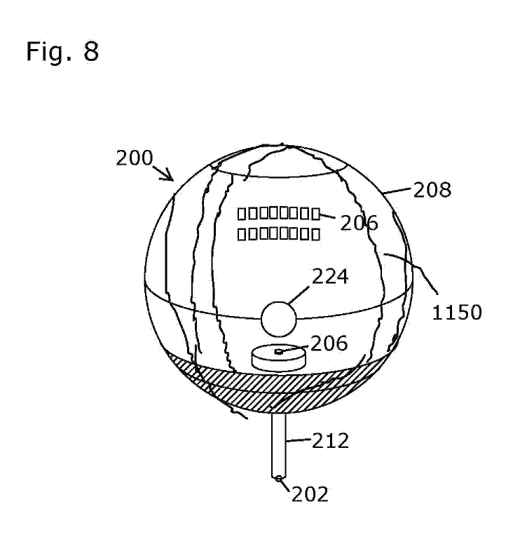

FIG. 8 presents a perspective view of a generalized ball or balloon audience unit.

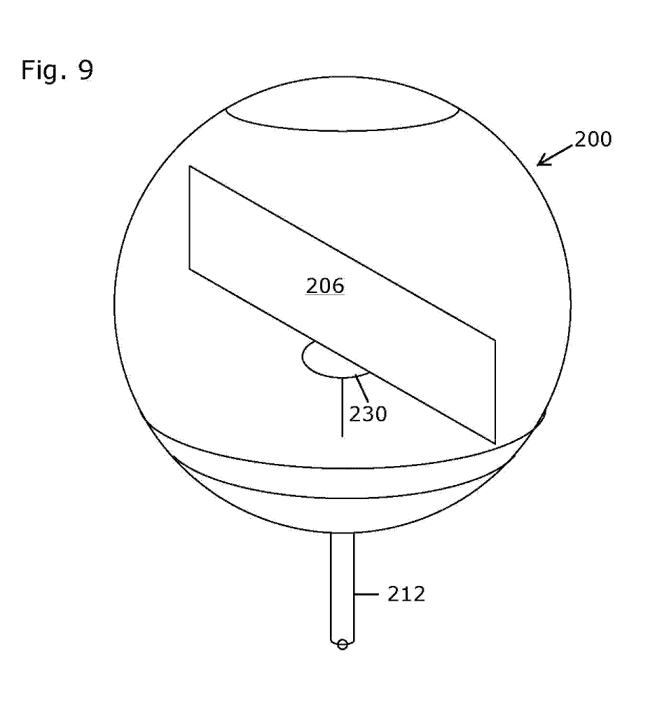

FIG. 9 presents a perspective view of a generalized volumetric audience unit.

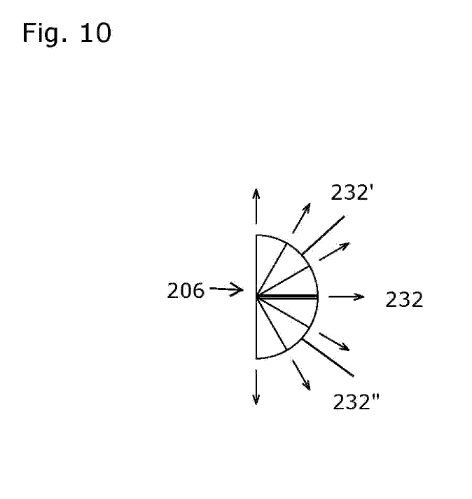

FIG. 10 presents a top view of a volumetric emitter element.

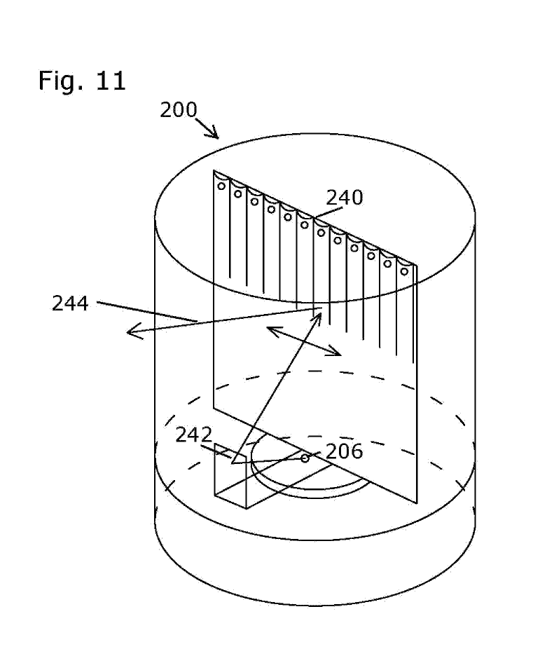

FIG. 11 presents a perspective view of a scan multiplier of a volumetric audience unit.

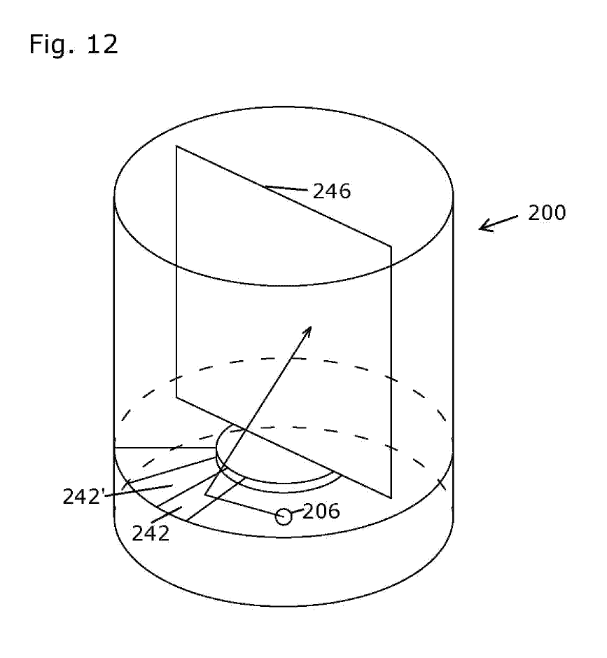

FIG. 12 presents a perspective view of an alternative scan multiplier.

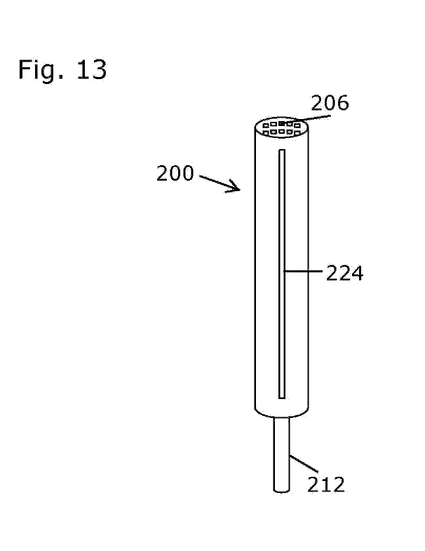

FIG. 13 presents a perspective view of a generalized autostereoscopic audience unit.

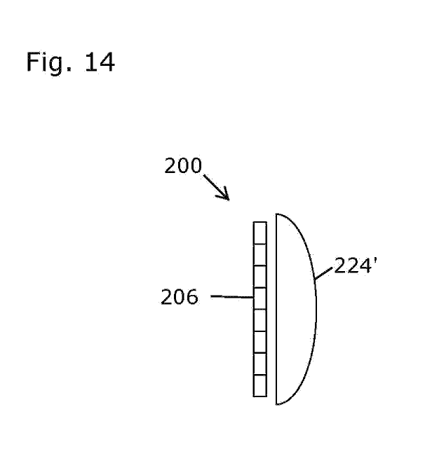

FIG. 14 presents a top view of a lenticular emitter element.

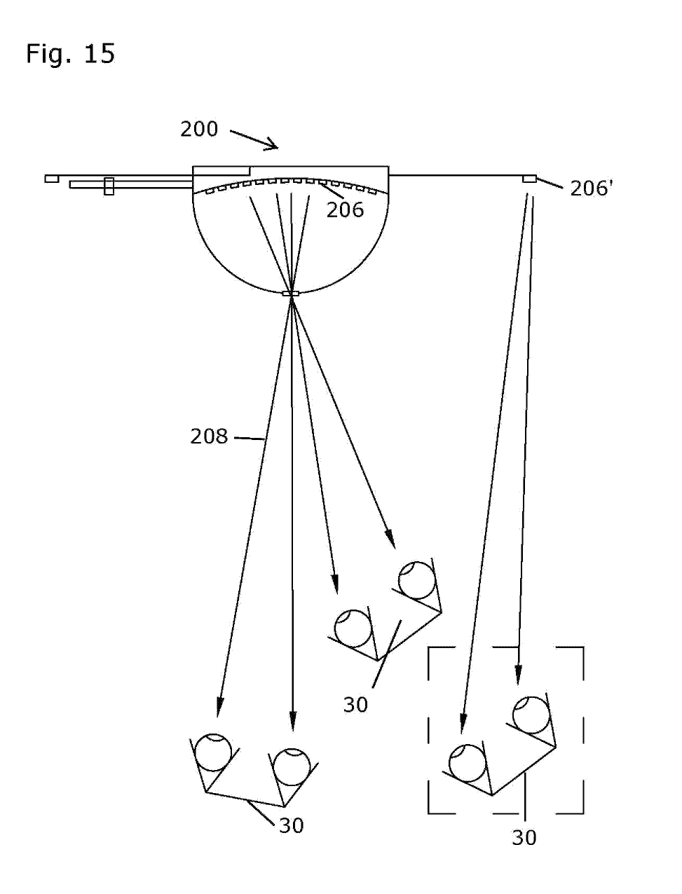

FIG. 15 presents a top view of a saccadic enhancement.

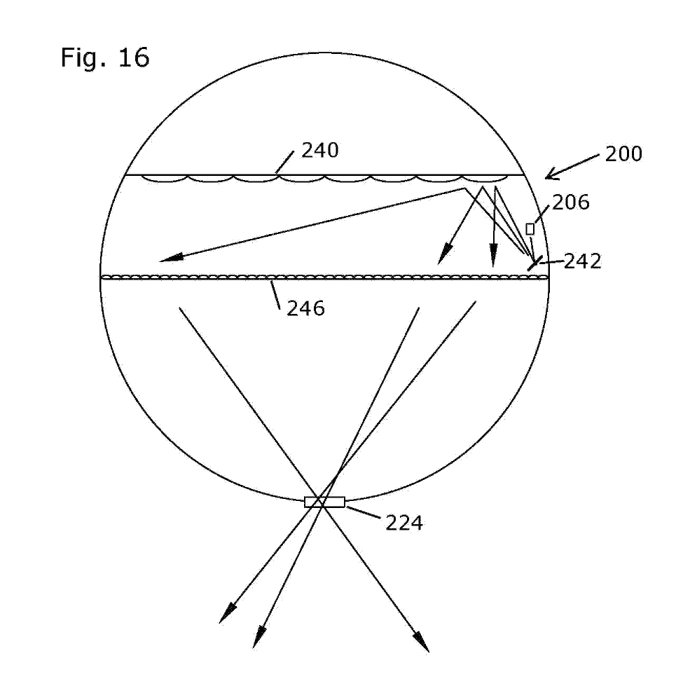

FIG. 16 presents a top view of a scan multiplier applied to an autostereoscopic audience unit.

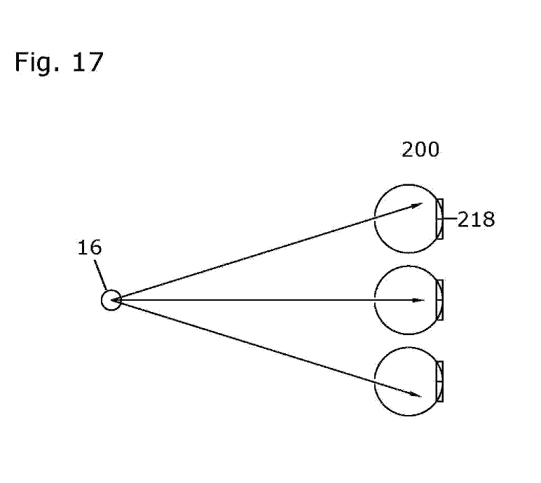

FIG. 17 presents a top view of a generalized registration beacon for the audience unit.

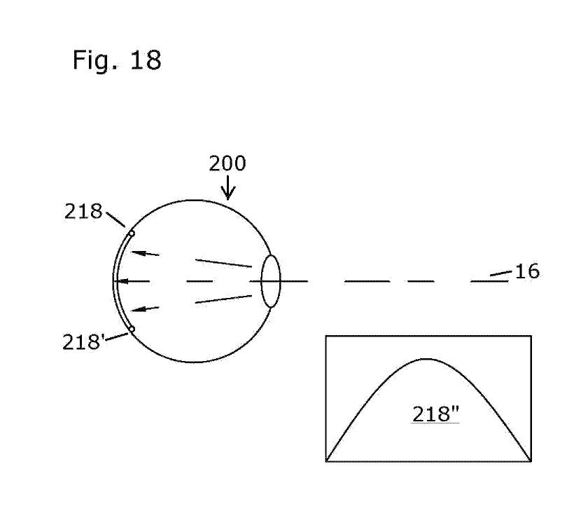

FIG. 18 presents a top view of an alternative generalized registration beacon system.

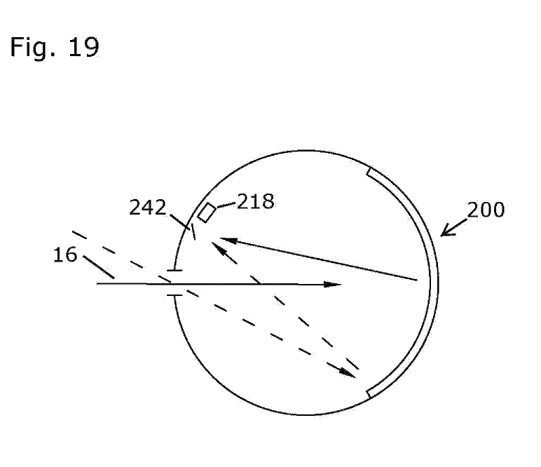

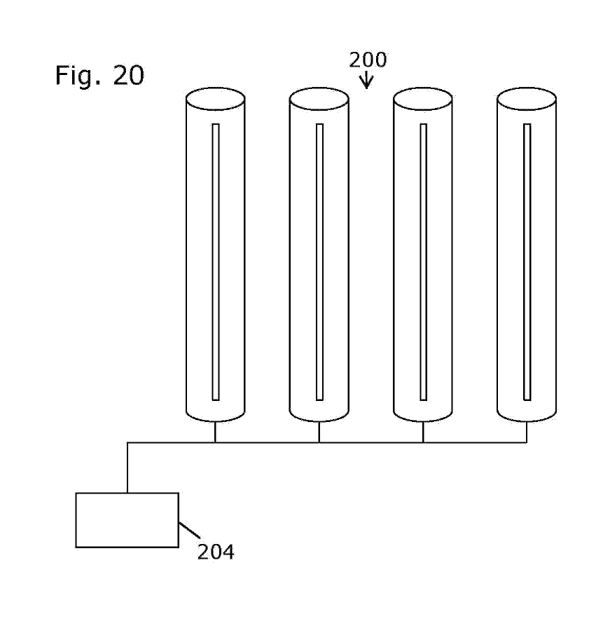

FIG. 19 presents a top view of an alternative generalized registration beacon system.

FIG. 20 presents a perspective view of an array of spaced-apart generalized audience units.

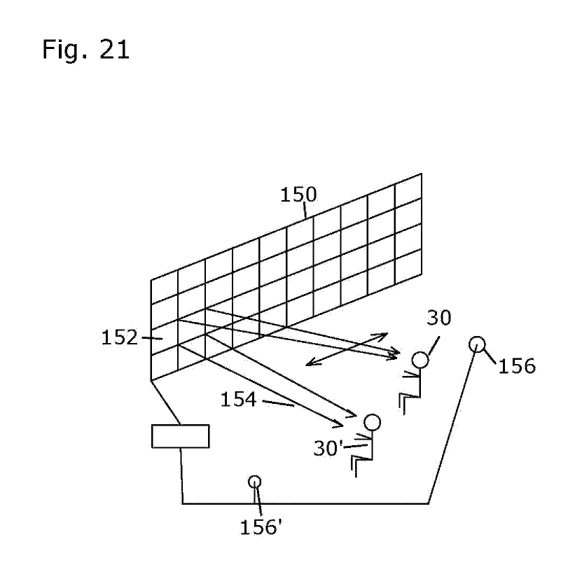

FIG. 21 presents a perspective view of a generalized projection wall.

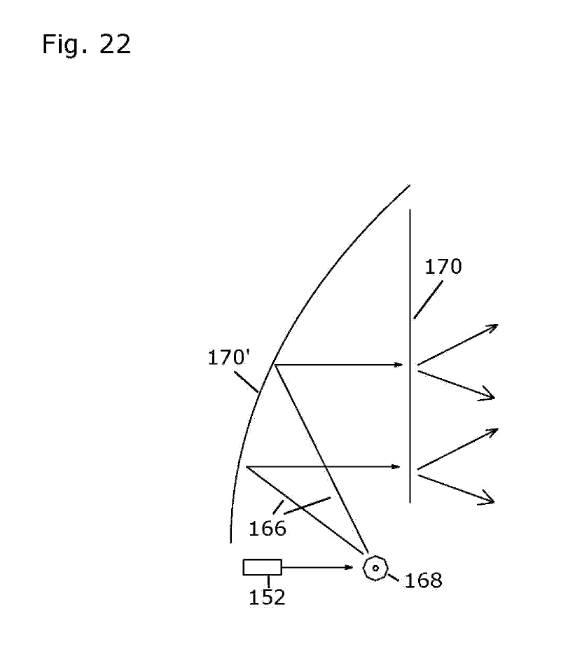

FIG. 22 presents a side view of a generalized scanning projection wall.

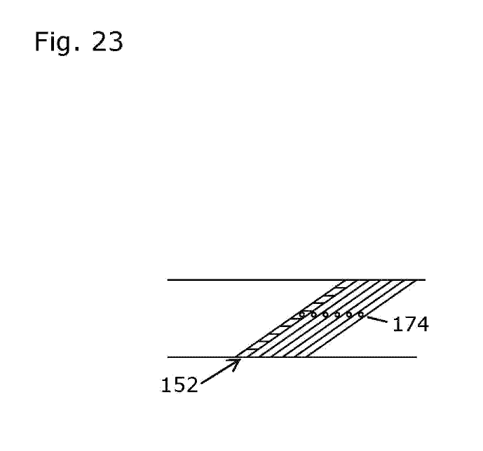

FIG. 23 presents a front view of a transform aperture array of the projection wall.

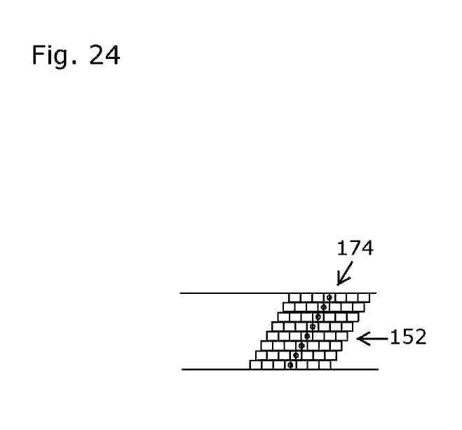

FIG. 24 presents a front view of another transform aperture array of the projection wall.

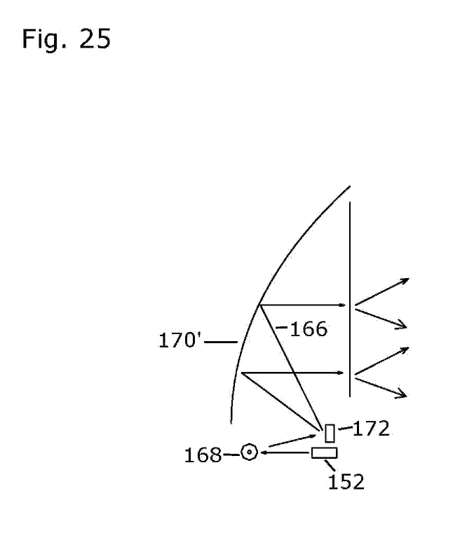

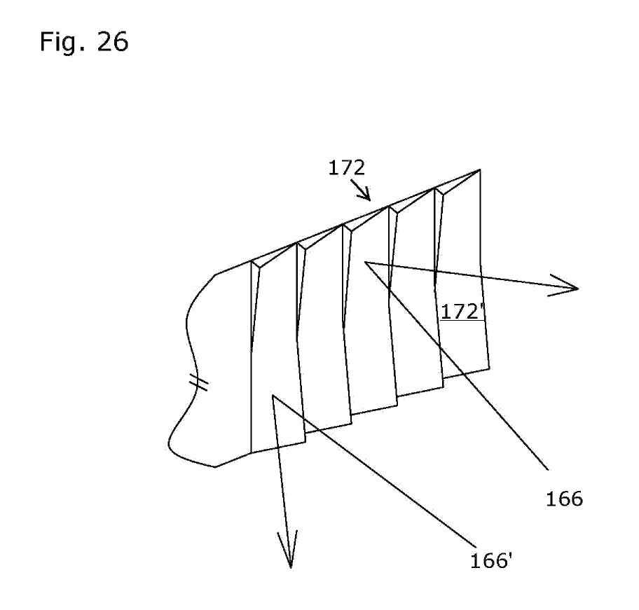

FIG. 25 presents a side view of a generalized compact scanning projection wall.

FIG. 26 presents a perspective view of an transform optics of the projection wall.

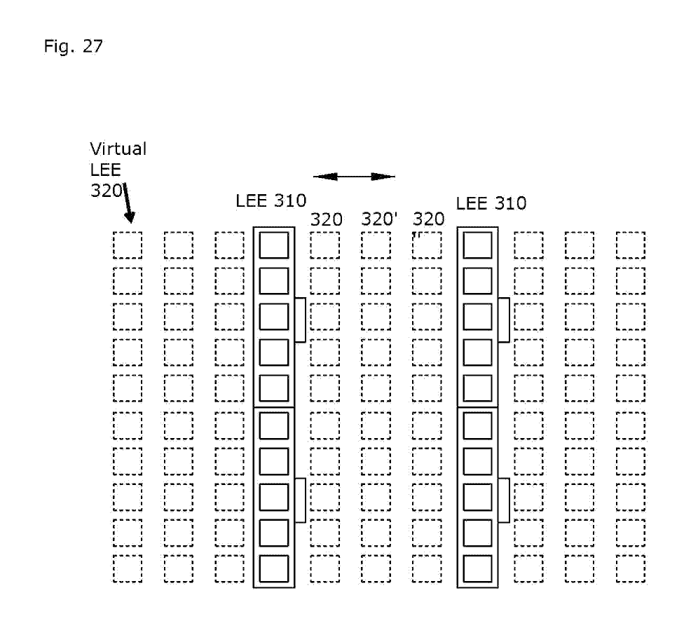

FIG. 27 presents a front view of resolution multiplier method.

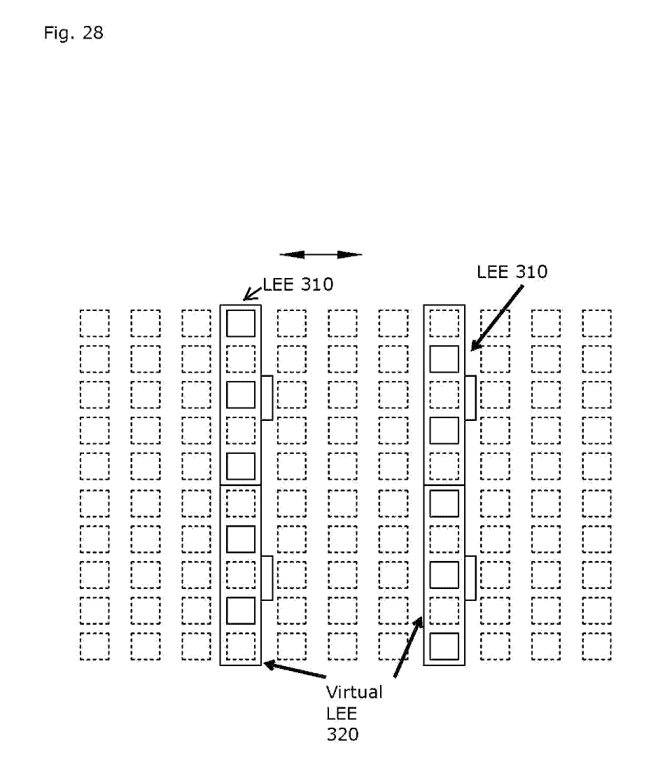

FIG. 28 presents a front view of resolution multiplier method.

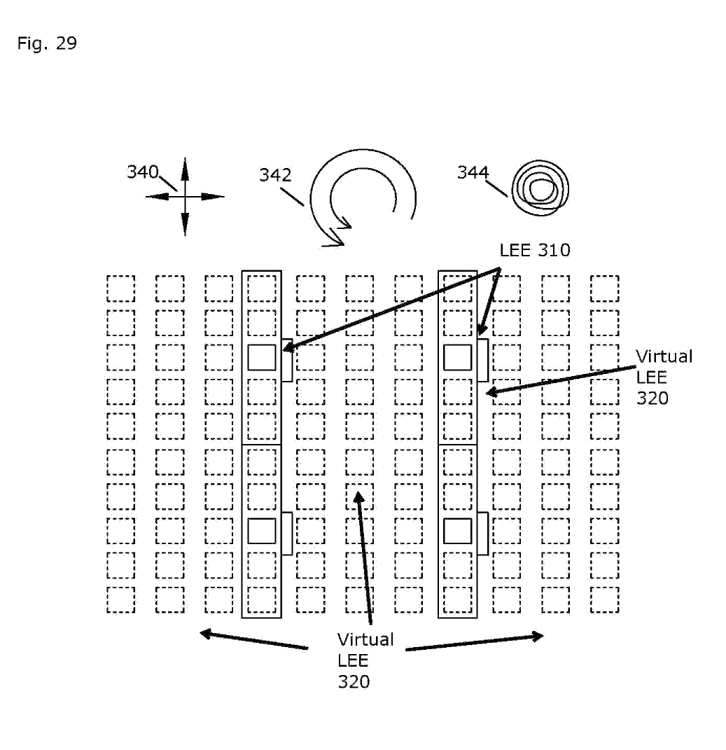

FIG. 29 presents a front view of resolution multiplier method.

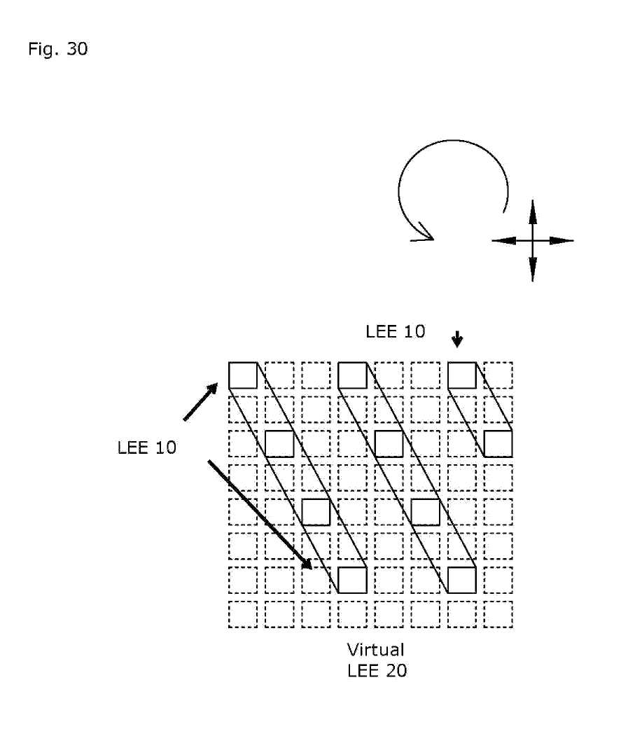

FIG. 30 presents a front view of resolution multiplier method.

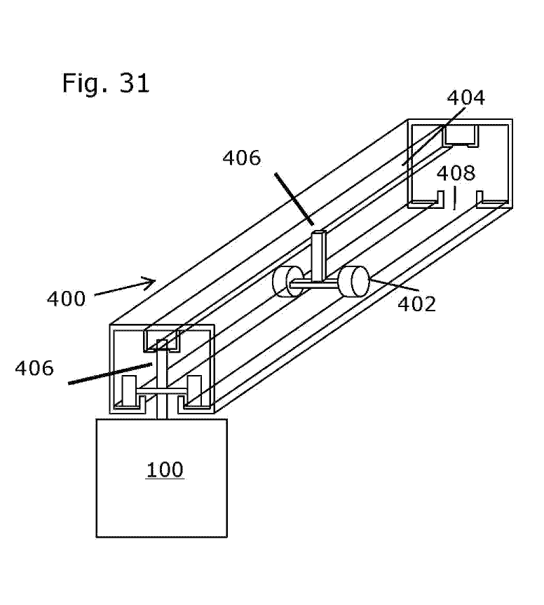

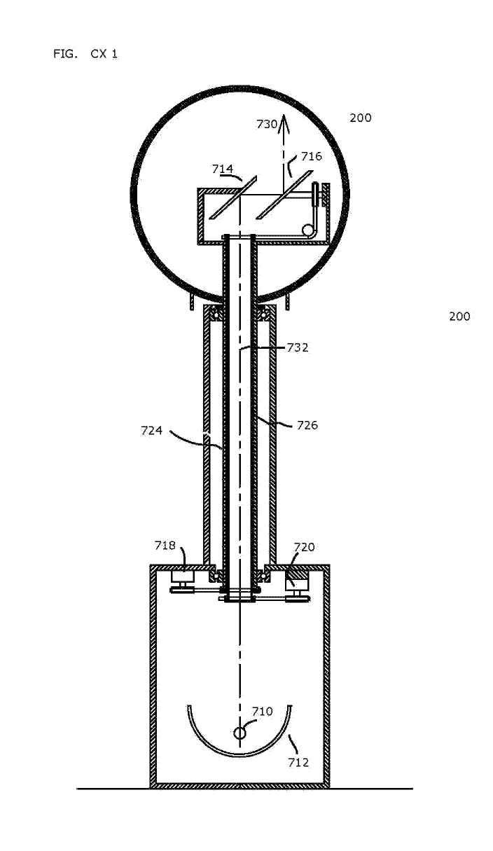

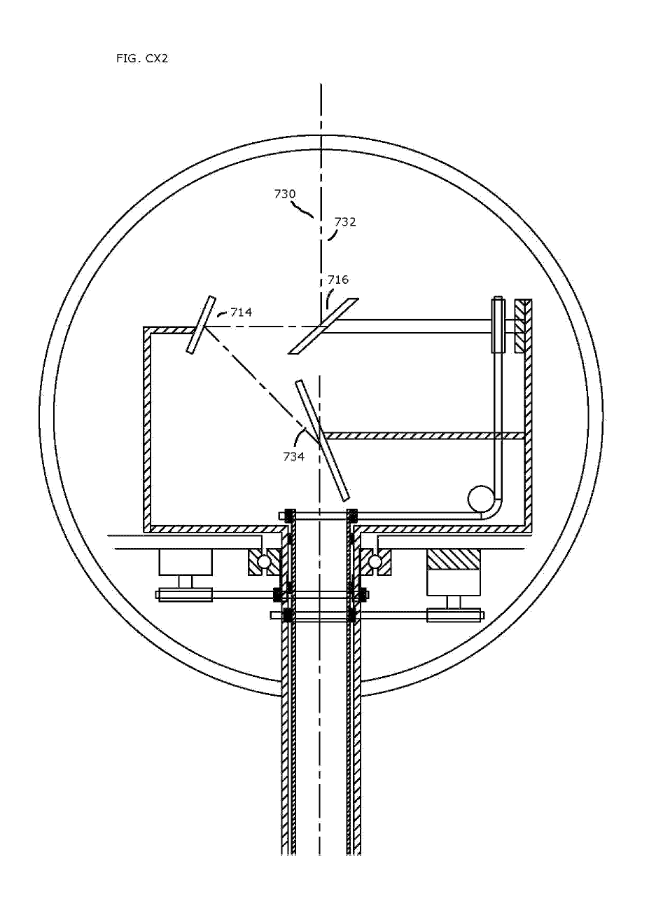

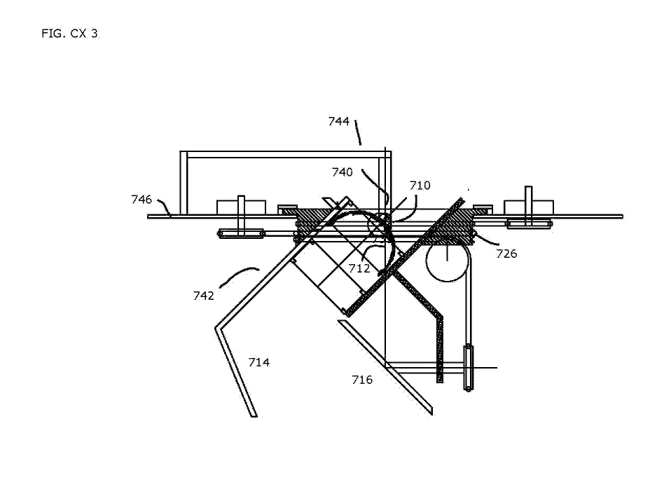

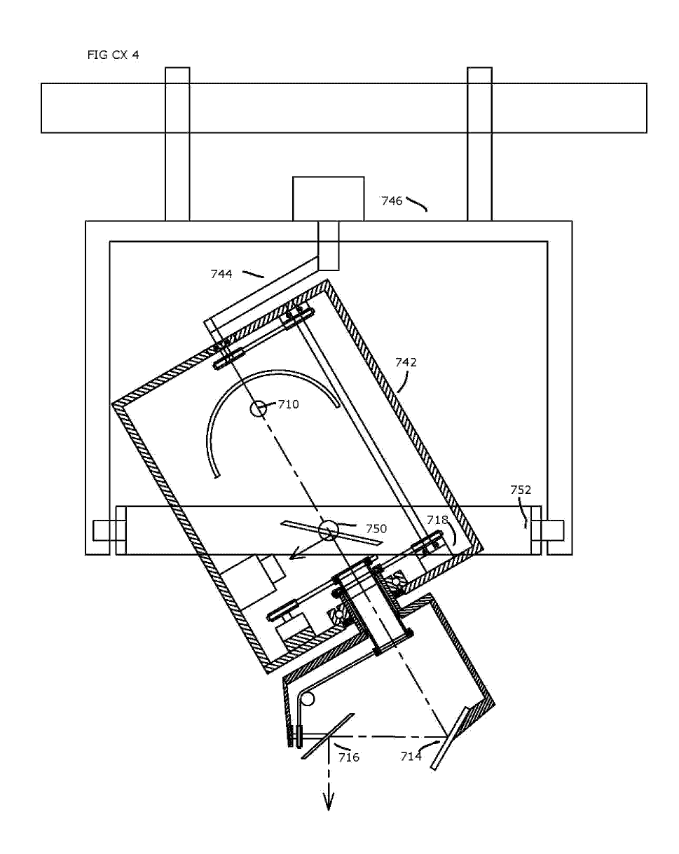

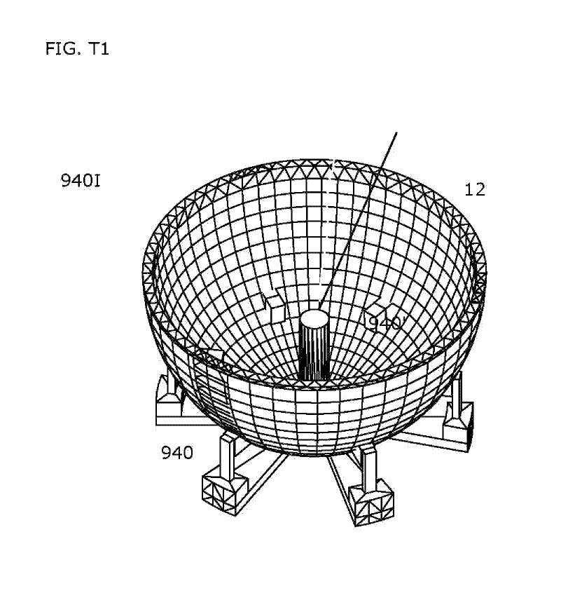

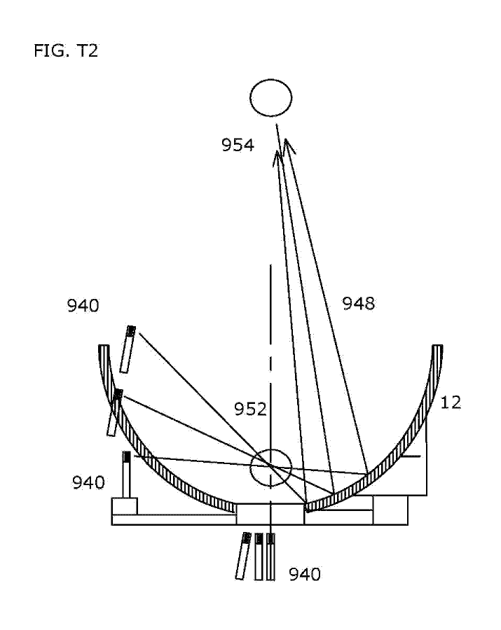

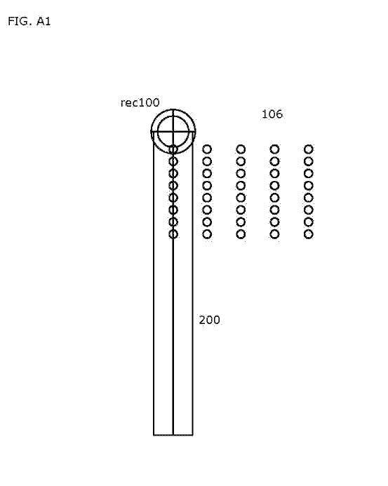

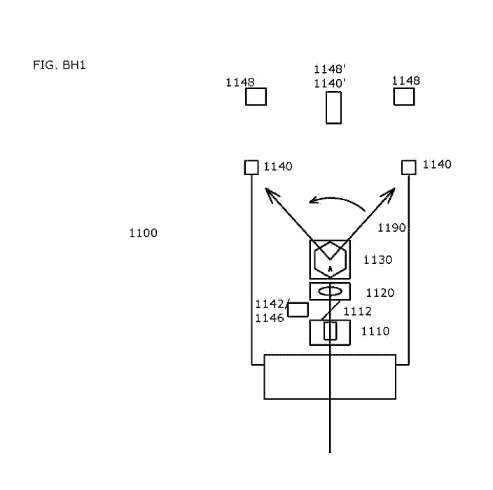

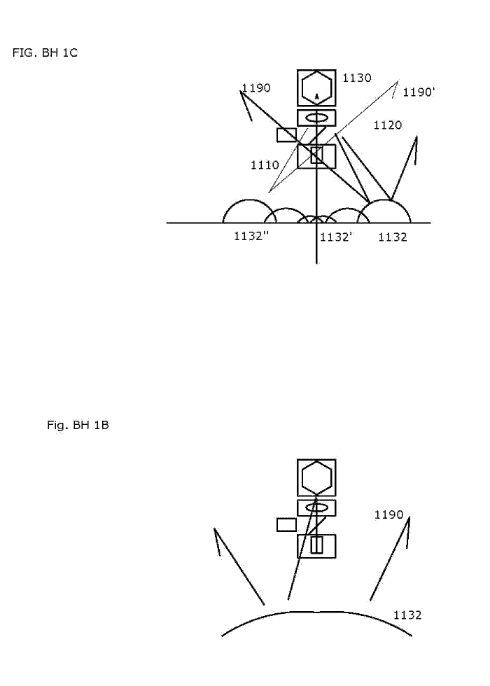

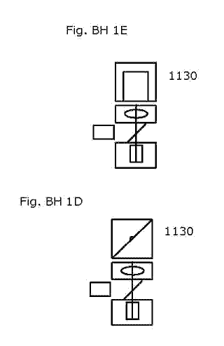

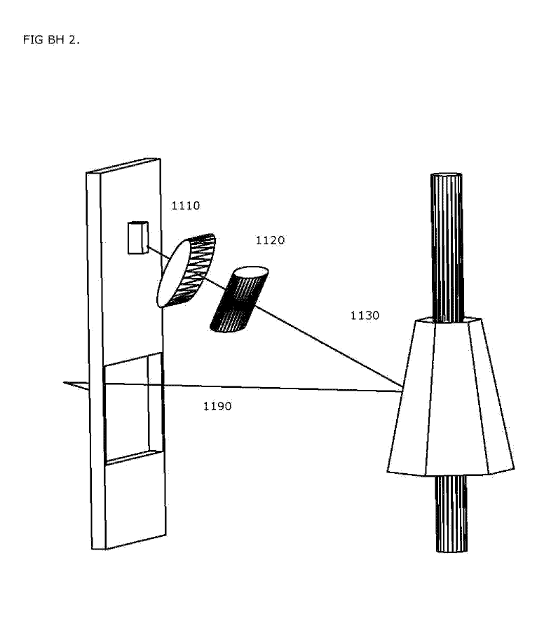

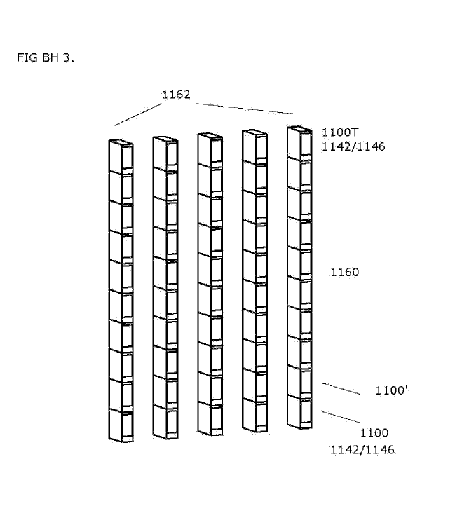

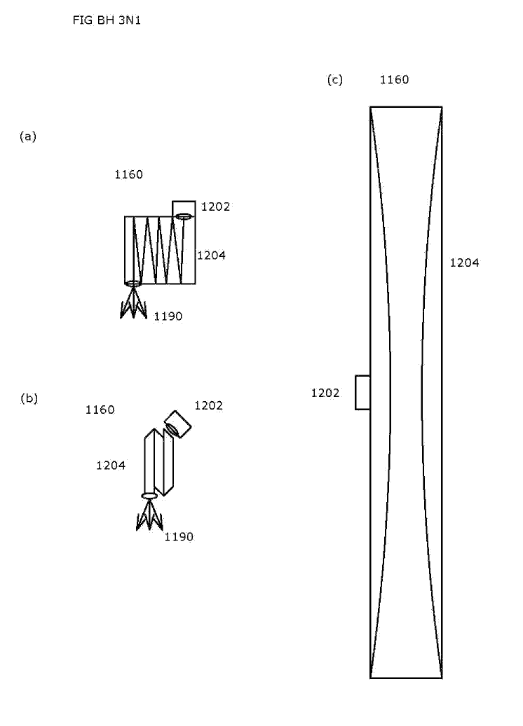

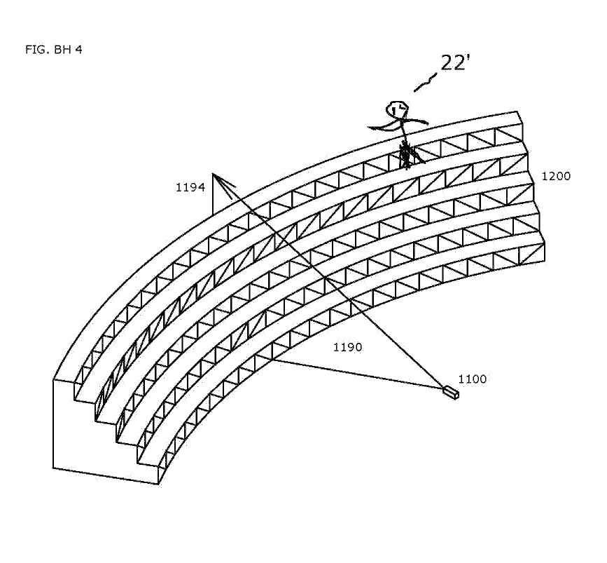

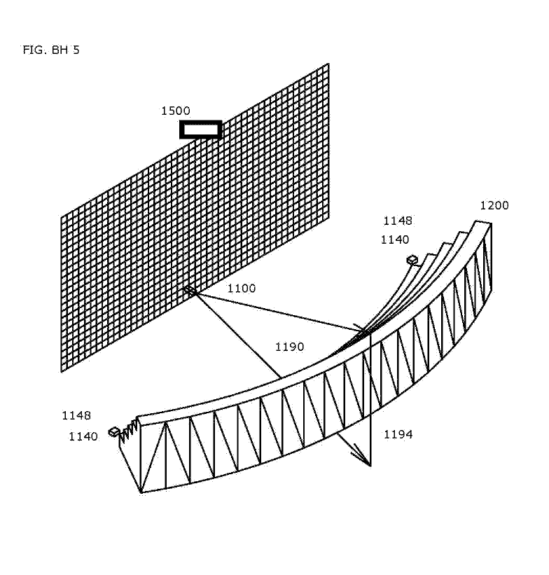

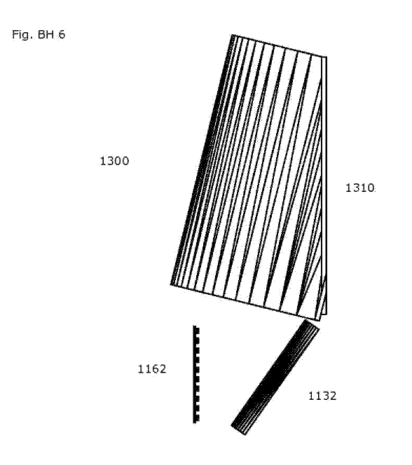

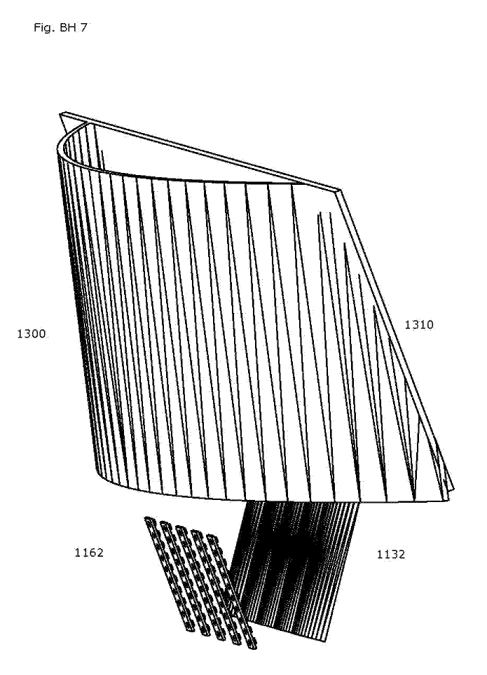

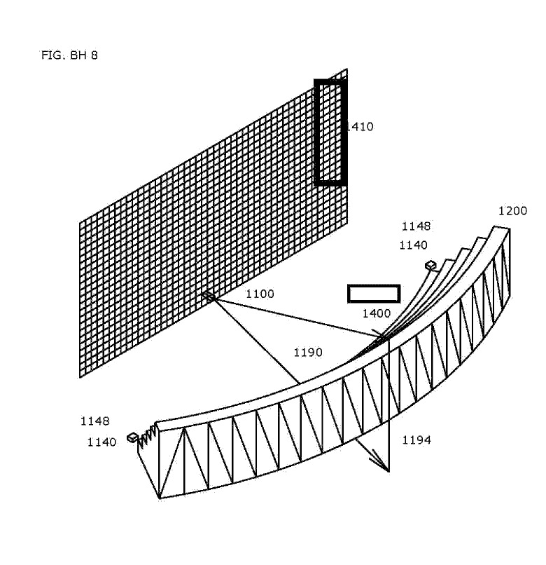

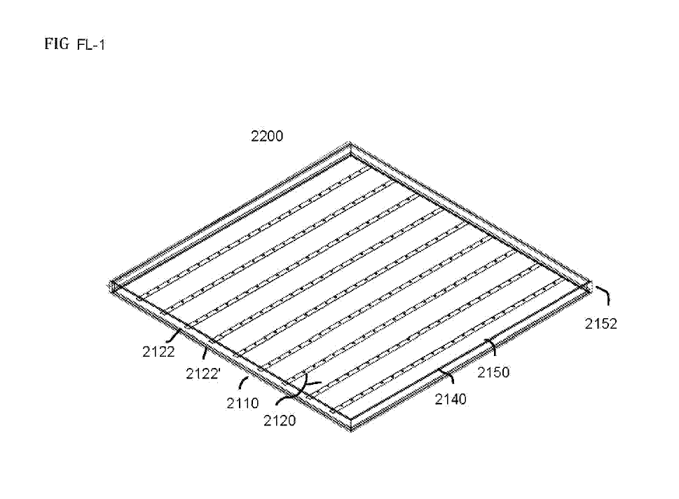

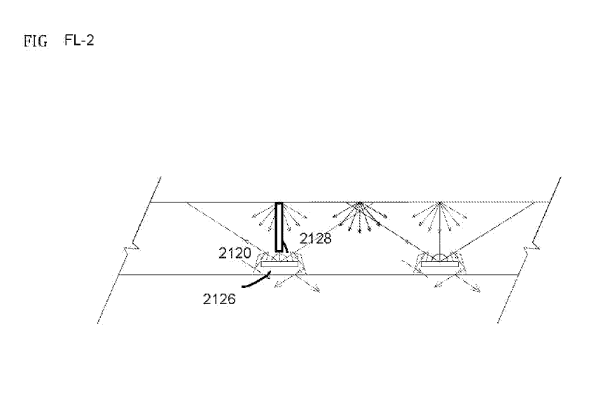

FIG. 31 presents a perspective view of a track and communications systems.

FIG. CX-1 presents a cross-sectional view of beam directional system for the projector/signal generator/camera units

FIG. CX-2 presents a cross-sectional view of a three mirror embodiment of beam directional system

FIG. CX-3 presents a cross-sectional view of an articulated embodiment of beam directional system

FIG. CX-4 presents a cross-sectional view of an bi-axially articulated embodiment of beam directional system

FIG. T1 shows a perspective view of a beam mixing embodiment of the present invention.

FIG. T2 shows a cross-sectional view of a beam mixing embodiment of the present invention.

FIG. A1 shows a saccadic virtual image from an audience unit

FIG. BH1 shows the basic building element: the 3D pixel.

FIG. BH1B shows an indirect scanned embodiment

FIG. BH1C shows an indirect scanned embodiment with a multiplicity of second reflection

FIG. BH1D shows a resonant scanner

FIG. BH1E shows a solid-state scanner

FIG. BH2 shows a perspective view of the basic elements of a single pixel.

FIG. BH3 shows a perspective view of a columnar array of single pixel

FIG. BH3-N1a-c shows top and side views of an SLM based column.

FIG. BH4 shows a front perspective view of a single pixel projecting a fan of light

FIG. BH5 shows a rear perspective view of a single pixel projecting a fan of light

FIG. BH6 present a compact, rear projection embodiment.

FIG. BH7 present a rear view of a compact, rear projection embodiment.

FIG. BH8 shows a rear perspective view of a single pixel projecting a fan of light

FIG. FL-1 is a simplified perspective view of the panel embodiment of the audience unit.

FIG. FL-2 is a simplified cross-section view of the light-redirecting optical element of the audience unit.

### DETAILED DESCRIPTION OF THE INVENTION

FIG. 1 presents the generalized elements of the performance display system 10 in a venue resembling an audience 22 with a plurality of audience members 22′ and stage 24. The venue may include any space ranging from the interior of an automobile, a living room, a dining hall, or nightclub to major event venues such as theatres, concert halls, football stadiums or outdoor festivals.

Although the term audience unit or audience receiver unit 200 is used to describe both the simple and autostereoscopic-effects unit, it may be understood that the module may take any shape or be incorporated into any independent handheld, worn, or positioned effects device including but not limited to tickets, badges, buttons, globes, cylinders, signs, sashes, headdresses, jewelry, clothing, shields, panels and emblems affixed or held to a member of the audience or any object, moveable or stationary.

The insert in FIG. 1 presents a front view of the present invention having an illuminated audience unit 200 with some or all of the elements of the audience unit of FIG. 1, having one or more light emitting elements 206 which may be referred to as light emitters or modulators, light modulator, light emitting/modulator elements, LEDS, light emitter or light array, a connecting member 214, handle 212 and an active receiver 202 capable of receiving optical or acoustic signals.

In operation, the show director at the control board 18 or instrument sends a sequence of commands, live or from a stored visual or audio program, over the performance system data network 14 to the projector/signal generator 100 which emits a precisely timed series of directional signals 106, 106″, 106″ programmed to activate the audience units 200 at a precise location impacted by the directional signal 106. In its simplest embodiment, the projector/signal generator 100 displays an invisible IR 106 image at a specific wavelength (880 nanometers, for example) on the audience 22 which causes the wavelength-specific audience unit communication receiver 202 to activate one or more light emitters or modulators 206. The projector/signal generator 100 may also transmit a program sequence for later execution and display. Each audience unit may contain a unique encoded identifier entered during manufacture; at the time of purchase or distribution; or transmitted by the projection system to the audience at any time, including during the performance. The data protocol may included well-known communication protocols such as but not limited to IR RS-232, IRDA, Fiber Channel, Fiber Ethernet, etc.

The projector/signal generator 100, referred to hereafter principally as “projector 100”, may also project a visible light beam containing visual content as well as a data stream by modulating the frequency above the human visual system integration frequency of 30 Hz. It may be understood that the projector/signal generator 100 in its photonic form encompasses the simplest gobo projector as well as the most complex, integrated terahertz-modulated photonic signal generator and spatial light modulator.

The Light emitting elements 206 may refer to any type of photonic source such as but not limited to incandescent, fluorescent, neon, electroluminescent, chemical, LED, laser, or quantum dot; or to combinations of light modulating combinations such as but not limited to thin film LCDs, backlit or reflective, E*INK type reflective modulators, chemical, photonic or electronic chromatic modulators.

A camera system 300 may be employed to monitor the audience and/or audience units, and provide feedback for a number of manual or automated design, setup and operating procedures. The camera system may be incorporated into the projector/signal generator unit 100.

If not properly configured said data signals 106 may interfere and degrade the rate and integrity of transmission. In order to synchronize the data projectors 100, a time code signal may be transmitted from the system control board 18, a designated master controller 100. Each data projector 100 may be programmed with a calculated offset from the time-code signal based on its distance from ‘center of mass’ of the audience, the location of other controllers, external environment, and other factors. A central time-code beacon 140 may transmit the time-code signal to each of the data projectors 100 by means including but not limited to photonic, acoustic, or RF signals.

A feedback system from the cameras 300 may be used to adjust the performance including but not limited to projecting a fine pattern and adjusting the intensity of the data signal 106 until the appropriate resolution is achieved. The audience unit may employ an IR or other non-visible emitter for adjustment, diagnostic and other purposes. Various user input devices including microphones, buttons, switches, motion detectors, gyroscopes, light detectors, cameras, GPS and other devices may be included 216.

FIG. 2 present a simplified embodiment of the projector 100 element having one or more data and/or light emitters/sources 102/104, an visible light modulator 112, an data modulator 110, an combiner 114, a lens projection system 118, a beam scanning system 120 and a mounting system 122. In operation, the projector 100 projects a temporally and spatially modulated data and/or visible image 106/108 in response to commands from the control system. The internal and networking optics/electronics are not shown but may include the well-known elements in networked or independent digital video projectors.

FIG. 3 presents a depiction of a rapidly scanning projector 100 projecting an image 124, 124′ which would normally appeared blurred, or have its data scrambled, due to the rapid motion. A motion-defined distortion 126 of the static image 124″ may be introduced to correct this problem. Adjustments for chromaticity and brightness may also be employed.

FIG. 4 presents a simplified embodiment of the audience unit 200 which is representative but not limiting of the handheld embodiment of the audience unit may include a communication receiver 202, a microcomputer 204 which may be combined with the communication receiver 202, least one LED or light modulator 206, and a power source 210 which may included but is not limited to a small battery, a photovoltaic cell, a mechanical, chemical or piezo-electric electrical generator, etc. This unit may be part of the event ticket, sandwiched between layers of paper, and as a button, pen, necklace, earrings or adhesive sticker, for example. A sound emitter acoustic speaker 208 may be included in the unit 200. Various user input devices including microphones, buttons, switches, motion detectors, gyroscopes, light detectors, cameras, GPS and other devices may be included 216.

One example of the low cost and simple construction of the preferred embodiment employs a supporting plastic tube 212, an IR receiver 202 used in TV remote controls, a Microchip PIC microprocessor 204, a linear array of light emitting diodes (LEDs) or reflective E*Ink light modulators 206, and a 3V disk battery, mounted on a mounted on FP4 circuit board. A lanyard may be provided. In operation, the unit 200 may be held stationary and employ a complex saccadic image disclosed by Bill Bell. Additionally, the unit 200 may be placed on a fixed or moving base structure.

Utilizing the novel features disclosed in the present invention, the visual and audio response is precise and independent of the dynamic location of the member of the audience or audience unit. Further, as a further benefit of the novel features and combinations of the present invention, the cost of implementing the method of the present invention is substantially less than other approaches and for the first time, practical and competitive in the marketplace. The performance audience unit display system may be employed at any assembly, large or small, or applied to any structure. Also, the audience unit display may be incorporate a message, song or game, and continue to operate after or independent of a performance or assembly.

The audience unit 200 may incorporate a motion sensor or other position sensing means and be programmed to respond to various motions. In one preferred embodiment, a proscribed motion would be encoded, either in code or by transmission from the signal generator/projector, and the audience unit 200 would respond—visually, aurally, tactile, or other effect—based on the audience member's specific deviation, instantaneously or over time, from the proscribed path.

FIG. 5 present a generalized banner embodiment of the active audience unit 200 showing the communication receiver 202, one or more light emitting/modulator elements 206, and a pressure/location switch 220 which is activated when the banner is waved and controls the timing and direction of the image displayed. The other previously-described elements, such as the computer, power source, sound emitter/speaker, and handle which may be incorporated, are not shown in this and following figures.

FIG. 6 presents an embodiment of a spinner-type audience unit 200 shown as having an array of LEDS 206 which rotably attached to a handle 212 by rigid, flexible or folding connecting member 214. The insert shows a top view of the trigger sensors or switches 222 which may include a multiplicity of irregularly spaced switches 222′, 222″, 222″. The irregular timing pattern produced during a regular rotation may be used to determine direction and orientation of the unit 200.

FIG. 7 shows a top view of the clip-on embodiment of the spinner-type audience unit of FIG. 6 where the timing switch 222 is integrated with at least one pair of snap contacts 222′,222″ on the handle end 212 of the connecting member 214 which close a circuit with handle contact 238. The contact 238 may extend to include an upper and lower connecting member 214, if two, rather than one, are used. Multiple contact regions 238 may be employed to enable irregularly spaced switches as described in FIG. 6.

FIG. 8 shows a balloon or ball embodiment of the audience unit 200 having a clear, translucent, or opaque surface 208, one or more light modulators 206 and the data receiver 202. In the airborne balloon embodiment, the receiver 202 may be positioned at the bottom of a handle which may incorporate the light emitter 206, microcomputer and power supply and shift the center of gravity of the unit 200 such that when released the receiver 202 is oriented at the bottom of the unit 200. The light/color emitters/modulators 206 may be placed on the surface (including constituting the polymer surface) or internally. Elements causing rotation, sound, scent and vibration may be incorporated.

FIG. 9 shows an audience unit 200 with a rotating light array 206 mounted on a position encoder (such as an incremental or absolute optical encoder) affixed to the handle 212. In operation, the individual light elements of the array 206 may be modulated to produce a three-dimensional volumetric or autostereoscopic image.

The audience unit may be used independently as a display.

FIG. 10 shows a top view of individual element 206 having controllable projection sectors 232. The sectors may be utilized to produce three-dimensional images with improved readability, occlusion and stereoscopic image disparity. A vertical, central, narrow sector 232 may be used to enable an autostereoscopic mode, while the right/left sectors 232′, 232″ may be used to present hemispheric limited images to observers.

With a fine resolution, occlusion and multiple autostereoscopic modes may be programmed. The fine resolution may include X-Y sectors similar to integral photography.

FIG. 11 shows an audience unit 200 with a rotating light array 206 having a scan multiplier 240 in the form of a reflective lenticular array. A transmissive embodiment may also be employed. A reflective or transmissive integral photographic array may be employed with the image scanning in two-dimensions. In operation, the projection of the light array 206 is scanned by the scanner 242, shown on a distal arm affixed to the scan multiplier 240, but may be placed in any beam path position, resulting in a multiplicity of directional beams

FIG. 12 shows an audience unit 200 with a rotating light array 206 having a scanner 242 in the form multiplier in the form of a static reflective or transmissive lenticular-type array upon which the projection of the light array 206 is directed. Each sector 242′ of the static scanner 242 may describe a full or partial traverse of the image screen 246.

FIG. 13 shows an audience unit 200 in the form of autostereoscopic column having a light array 206, a view aperture 224 and a handle 212. The unit may be used in a moving, static or saccadic mode. Internal motion sensors, not shown, may automatically switch between modes.

FIG. 14 shows a top, cross-sectional view of the lenticular lens, light array embodiment of the autostereoscopic column showing the light array 206 and lenticular lens 224′. With the advances in the brightness and complexity of MOEMS technology, the miniaturization of the elements of the autostereoscopic unit is progressing rapidly. With the lenticular lens 224′ is shown as anamorphic in the viewer's horizontal direction X, an X-Y construction may be employed resembling an ovoid lenslet for each element of the light array 206.

FIG. 15 shows a top, cross-sectional view of an autostereoscopic unit 200 showing the light array 206, view aperture 224, visual beams 208, and observers 30. An additional light element, the saccadic initiator 206′, is shown which is used to initiate the observer's saccadic movement by preceding and alternating the display of the saccadic image.

While there are many methods to create the light array 206 ranging discrete LEDs to complex, rapidly scanned lasers, the global orientation of the individual units 200 is extremely important in order to display a composite, group image containing stereoscopic image disparity.

FIG. 16 shows a top, cross-sectional view of an autostereoscopic unit 200 showing an scan multiplier in the form of a reflective lenticular-type 240 which directs the image of the light array 206 scanned by scanner 242 on image screen 246. In operation as shown in the figure, a scan rate of 30 Hz may be multiplied eight times with the proper coordinate modulation of the light array 206. In all the embodiments of the present invention, the feedback sensors or orientation receivers may be employed to improve the performance.

FIG. 17 shows a top, cross-sectional view of an autostereoscopic unit 200 showing an orientation sensor 218 receiving the projection from an orientation beacon 16. The beacon 16 may be the image from a projector 100 or projector element 152.

FIG. 18 shows a top, cross-sectional view of an autostereoscopic unit 200 showing two orientation sensors 218, 218′ receiving the projection from an orientation beacon 16 and interpolating the unit's orientation based on the relative intensity 218″ of the sensors.

FIG. 19 shows a top, cross-sectional view of an autostereoscopic unit 200 showing orientation sensors 218 and scanner, 218′ receiving the projection from an orientation beacon 16 determining the unit's orientation based on the scanner position.

FIG. 20 shows a perspective view of a multiplicity of autostereoscopic units 200, spaced apart, and networked to a central computer 204. Multiple units may be used to create an autostereoscopic screen, placed adjacent or with substantial spaced between each one. Saccadic timing may be employed to increase the apparent resolution.

FIG. 21 presents an important optical configuration applicable to all embodiments of beam holography necessary for a continuous image. This improvement may be incorporated in direct beam and all embodiments of scanning beam holography. Referring to FIG. 21, the projection wall 150 is comprised of an array of individual projection matrix elements or pixels 152, each of which projects a narrow projection beam 154 which scans across the audience observers 30, 30′ at approximately 30 Hz or greater. The projection beam 154 may be a thin vertical line for horizontal image disparity. The scan field of view ranges from scan limits shown as scan limit locations feedback sensors 156′ to 156. The scan field of view is partitioned into individual scenes, which may be defined by interpolating the signals from the corresponding feedback sensors 156, 156′ at the scan limits to adjust the frequency and timing of the projection from each wall element 152. For a beam holographic view, each projected line and scene partition has an arc length less than the inter-ocular distance of approximately 2 inches at the maximum beam holographic viewing distance. At finer resolutions that detailed image disparity increases.

All number of novel and known scanning technologies may be employed to achieve this optical improvement. They include mechanical resonant or rotating mirrors, acousto-optic, electro-optic, or piezo-optic scanners, resonant displaced light sources and other known scanning methods. MEMS fabrication may be incorporated. A summary of techniques is discussed throughout. It may be understood that an alternative construction may substitute moving pixels for static pixel, and scanner mechanisms in all embodiments.

In all the discussed embodiments, the optical components may be substituted by reflective or transmissive elements, using fiber-optic, MEOMS, HOE, or micro-optic fabrication technologies known in the field.

The scanning method shown presents the audience with proper horizontal parallax. Vertical parallax may be presented by incorporating additional, independently modulatable domains, which project a uniquely composed projection line 24 above or below the principal line 154. The additional domains may be inculcated by additional discrete light sources with each pixel 152, or a vertical scanning mechanism.

In order to achieve high registration accuracy in a high-resolution system, partition feedback sensors 156, 156′ are placed in the path of the projected beam. The sensors may be responsive to an infrared or other non-visible beam. The sensor output is transmitted to the image controller 30, which modulates the pixel 152 emissions. Various sensor methods may be employed including discrete partition sensors 156, 156′, sensors at the scene field of view limits 156′, 156 or other configurations. When employing discrete scene sensors the signal may be used to directly update the scene from an image buffer either in an incremental or absolute mode. When employing sensors at the scene field of view, the period between signals may be divided into partition periods, and the timing counter used to update the scene from an image buffer.

Each wall element 152 may be comprised of one or more pixel light sources and an individual or common horizontal scanner. A vertical scanner may be also be common to all pixels 152 or individually incorporated. An audience vertical field of view optical component in the form of a horizontal lenticular screen, which vertical expands the pixel into a projection line 154 may be included. Examples of the construction include a horizontally oriented lenticular screen, holographic optical elements, micro-fresnel or other micro-optical arrays.

FIG. 22 presents a side view, cross section of a linear screen pixel array, reflective embodiment of the present invention. A horizontal array of wall screen pixels 152 with internal horizontal scanning directs its beams 166 onto a vertical scanner 168. The beams 166 are directed to the display redirecting reflector 170′ and onto the audience field of view optics 170 which expand the beam in the vertical. It may be understood that the audience vertical field of view optics 170 may be incorporated into, or affixed to the display redirecting reflector 168. Alternatively, the display redirecting reflector 168 may be incorporated into the view optics 170 as a reflective, refractive, or transmissive optical element. The vertical scanner 168 may be a rotating polygon, resonant mirror, acousto-optic, electro-optic, MEMS or other known combination of transmissive or reflective scanning devices. For a high resolution, 15024 vertical line, 1528 partition presentation, at the ergonomic 72 Hz refresh rate, the calculations of pixel modulation and scan frequency are as follows:

Pixel Modulation (9.4 MHz)=Refresh rate (72 Hz) X Vertical Lines (1024) X Partitions (128) This rate may be reduced by adding additional rows of the linear screen pixel arrays which project onto adjacent or interlaced vertical domains.

The perceived pixel intensity is the pixel flux X surface solid angle projection (surface (double) integral X Efficiency Factor/pixel area at the observer. This is approximately the same as if the pixel was placed in a static 2D screen.

FIG. 23 shows a static X/Y array of projection matrix elements 152 transformed into horizontal linear array of projection apertures 174 by optically integrating a sequence of diagonal-arranged elements 152.

FIG. 24 shows a static X/Y array of projection matrix elements 152 transformed into diagonal array of projection apertures 174 by optically integrating a sequences of horizontally-arranged elements 152.

An alternative approach (not shown) may employ a dove prism as the transform optic for an regular or offset matrix.

FIG. 25 presents a perspective view of the static Autoview reflector embodiment of the present invention. The purpose of the Autoview reflector invention is to eliminate the multiple, individual high frequency horizontal scanning and control elements required by the prior embodiments and permit a compact horizontal incidence displacement scanner.

A static horizontal array of wall screen pixels 152 may be employed which direct its beams 166 onto a vertical scanner 168. The vertical scanner 168 has an offset construction to both scan and displaced the virtual source, and directs the beam 166 to the Autoview optics 172. The Autoview optics 172 are further described in FIG. 26. The beams 166 are then directed to the display redirecting reflector 170′ and onto the audience field of view optics 170 which expand the beam in the vertical.

FIG. 26 presents a perspective view of reflective embodiment of the Autoview optics of the present invention. The Autoview reflector 172 is constructed of Autoview reflector elements 172′ having a continuous or incremental optical displacement (twist) which are configured to cause the input beams 166, 166′ to deflect in different directions, based on the incident spatial position on the Autoview element 172′. It may be understood that the Autoview element 172 may be a continuous and incremental reflective surface, or in the reflective or transmissive embodiment constructed of a continuous or incremental holograms, holographic optical elements (HOEs), micro-optics, Fresnel, or other known static elements.

Registration and orientation sensors and feedback may be employed to improve performance.

It may be understood that while active Autoview reflector elements such as micromirrors, acousto-optic, or electro-optic beam scanner may be employed, they represent a distinct, separate and differentiable invention from the embodiments in the present application.

FIG. 27 shows a multiple column display 300 having a multiplicity of columns of emitters 310 (corresponding to projection matrix elements 152) with an intervening space filled with three virtual emitters 320, 320′ 320″. Bill Bell established that when multiple columns are placed with intervening spaces, the human vision system will integrate the image through saccadic motion and persistence of vision.

The quality of the perceived image is dependent on the timing and angular displacement of image real and virtual image, which Bell calculated from the normal saccadic angular velocity and period of visual integration. It works simply when the actual and virtual images 320 of the multiplicity of emitter columns 310 are consistent in timing and direction. When they are complex however, other useful effects occur, including a perceived increase in visual resolution, color depth and intensity and three-dimensional perception.

FIG. 28 illustrates an alternate spacing of LEE 310 within the respective columns by staggering the placement of the LEE 310 and increasing the number of contiguous virtual LEEs 320 by a factor of 2 plus 1. Other patterns more be employed.

FIG. 29 illustrates another alternate spacing of LEE 310 within the respective columns by reducing the number of LEEs 310 in both the horizontal and vertical dimensions. The virtual LEEs 320 may be presented in a Cartesian 340, circular expanding 342, spiral pattern 344 or other pattern.

FIG. 30 illustrates a diagonal, staggered spacing of LEEs 310 within the respective columns reducing the number of LEEs 310 in both the horizontal and vertical dimensions. The virtual LEEs 320 may be presented in a Cartesian 340, circular expanding 342, spiral pattern 344 or other pattern.

In operation, the resolution enhanced embodiments of the present invention overlay the display, which may any visual form (i.e. static, moving, video, text, abstract, etc.) image onto the matrix produced by the real 310 and virtual 320 light emitters, and sequentially illuminates the real LEE 10 with the corresponding real and virtual display pixels in accordance with the display patterns presented.

When applied in the manner of Duffy, the real LEE 310 is moved to the corresponding virtual pixel location. When applied in the manner of Bell, the virtual (or intermediate) pixels are sequentially displayed on the real static LEE 310, and the human visual system, by saccadic, cognitive or combinations of both, intercalates the virtual pixels and integrates the image.

The quality of the integration may be influenced by controlling the timing and luminosity of the display. Representative patterns include but not limited to:

1. Alternating direction and interlacing the rows

2. Using opposite circular directions

3. Employing a random

4. Weighting the motion by subject—saccadic pre-testing
i. Analysis
   1. Delta values
      a. Subject content
      b. Luminosity
      c. Chromaticity

Weighting the motion by subject provides substantial improvement in the perception of visual quality in part due to the integrative synthesis corresponding to the natural saccadic response. The method may be applied to pre-recorded images by using eye-tracking (eye-tracking devices are well known) on representative observer(s) to identify and quantify the visual highlight inducing the temporal saccade, and locally increasing the resolution, directing the motion and modulating the timing of intercalated images in response. Increasingly, real-time algorithms may be applied.

The aforementioned embodiments may be applied to two-dimensional or virtual 3D displays as shown in various display embodiments in these applications. These displays may be affixed to a structure or vehicle, attached to a mesh or backdrop screens or handheld.

FIG. 31 presents an automated track embodiment of the present invention where the projector 100 is movably affixed to a track system 400 having a carriage 402 with the option of motorized wheels controlled by a computer in each projector and communicating to the other projectors and a central controller by sliding contacts on the track. The electrical contacts may be through the wheels, suspending arms or independent brushes. The track may contain two or more power and communication channels. Communication may be through the power channels (X10) or through one or more separate lines.

Carriages are well-known and include those used for trussing, curtain movement, conveyers and other devices.

An improved optical communications system may be employed where the track 400 contains an reflective optical channel or conduit 404 having a opening 408 into which a projector transceiver probe 406 may be inserted. A reflective foil flap may close around the transceiver 406 probe. In operation, the optical communications signal is transmitted down the channel 404 and partially intercepted by the transceiver probe 406, which occludes only a small percentage of the cross-sectional area of the channel. Thus, multiple projectors 100 may be affixed to the track and simultaneously controlled and moved.

The system may include optical repeaters at designated intervals, and modular sections of any shape or path.

Integrated with the other elements of the present invention, the track further automates the performance display system.

The embodiments of the invention particularly disclosed and described herein above is presented merely as examples of the invention. Other embodiments, forms and modifications of the invention coming within the proper scope and spirit of the appended claims will, of course, readily suggest themselves to those skilled in the art.

### Notes

1. One or more Simultaneously-Emitting, Multiple-Directional Projecter(s) to a Multiplicity of Undifferentiated Display Elements

1.1. Handheld Display Element
1.1.1. Daytime
1.1.2. Nighttime
2. Projector Beam

2.1. Invisible (IR, UV)

2.2. Visible

2.3. Ultrasound

2.4. RF
3. Projector Beam

3.1. Invisible (IR, UV)

3.2. Visible

3.3. Ultrasound

3.4. RF
4. Projector as Display Wall

4.1. Continuous Beam Scanning (x-y)

4.2.
5. Projector is Compact (Portable)
6. Projectors are Robotic

6.1. On Track
6.1.1. Track has position information
6.1.2. Track has communication channel
6.1.3. Projectors are Wireless
6.1.4. Track is suspension cables
6.1.5. Projectors have position locking—(for transport)

6.2. Independent
6.2.1. On Wheels
6.2.2. Airborne
7. Projector as Luminaire

7.1. Static

7.2. Moving
8. VI

8.1. Single Scan—Occlusion

8.2. Single Scan—AS

8.3. Multiple Scan—Both

8.4. Active Multiplier
8.4.1. Reflective
8.4.2. Transmissive

8.5. Passive Multiplier
8.5.1. Reflective
8.5.2. Transmissive

### PARTS

| | |
|---|---|
| 10 | Performance System |
| 12 | PS Computer |
| 14 | PS Data Network |
| 16 | PS Global Reference Receiver/Beacon' |
| 18 | PS Control Board/Instrument |
| 20 | Venue |
| 22 | Audience |
| 24 | Stage |
| 30 | Observer's Eyes |
| 32 | Observer's Eyes |
| 100 | Data/Image Projector |
| 102 | Data Emitter |
| 104 | Visible Light Emitter |
| 106 | Direction Data Beam |
| 108 | Visible Light Beam |
| 110 | Data Modulator |
| 112 | Visible Light Modulator |
| 114 | Combiner |
| 118 | Lens System |
| 120 | Scanning System |
| 122 | Mounting System |
| 124 | Projected Image |
| 126 | Motion Adjusted Image |
| 128 | Orientation Sensor |
| 150 | Projector Wall |
| 152 | Projector Wall Matrix Element |
| 154 | Projection Line |
| 30 | Observers Eye |
| 156 | Projection Scan Limits Feedback sensors |
| 166 | Pre-scanner Beam |
| 168 | Scanner |
| 170 | Viewer Screen (horizontal lenticular, for example) |
| 172 | Autoview Optics |
| 200 | Audience Unit |
| 202 | AU Communication Receiver |
| 204 | AU Computer |
| 206 | AU Light Emitter/Modulator |
| 208 | AU Sound Emitter |
| 210 | AU Power Source |
| 212 | AU Handle |
| 214 | AU Connecting member |
| 218 | Orientation Sensor/Receiver |
| 220 | Pressure Contact for Registration |
| 222 | Switch/sensor |
| 224 | View Aperture (Integral Photographic Autostereography) |
| 226 | Weight |
| 228 | Balloon/Ball |
| 230 | Rotating Motor with Position Encoder |
| 232 | Light element projection sectors |
| 238 | Handle Contact |
| 240 | Scan Multiplier Lenticular Array |
| 242 | Scanner |
| 244 | Directional Beams |
| 246 | Image Screen ( |
| NEW | |
| 300 | Audience/Stage Camera System |

Audience Unit—Balloon

FIG. 8 shows a balloon embodiment audience unit 200 of the present invention, each having one or more connecting members to other unit 200′. Incorporated effects module may be a mechanical, electronic, photonic or other device which produces a visual, auditory, olfactory, or other effect. It may include all of the features of the audience units described in this application.

Additionally, the controller may control the altitude and propulsion elements 158 described in my related disclosures. The power source may be a battery and/or photoelectric cell. The communication link may be wire, RF, acoustic, or photonic—at visible or non-visible wavelengths—or a combination. While the present invention is presented as a balloon shape, it may be of any dimension or shape, including but not limited to spherical, rectangular, cubic, tubular, tonic, polygonic, etc. The manifold placement of the connecting members and other features for the variations will be understood from the following description.

The present invention may function as a floating visual screen with each visual effects element controlled by a central computer on the ground. Control may include my AE comm. projector at non-visible wavelengths. The effects may include the projection of visible light onto the balloons 200′ from any source

Tethers may be provided to stabilize the assembly, and may function as connecting members and communications links. A simple, ground-based embodiment may have the tethers running through attachment loops on the balloons

Many other connection configurations are possible, including but not limited to ball and socket, snaps, electrostatic surfaces, hook and loop. Detachment mechanisms may include electromotive, photoactive, piezo-acoustic actuators, levers, hooks, fabrics, etc. Infrared LEDs may be employed to heat a element, voice coil actuators to alter a magnetic field or solenoid, fusible links to detach a hook.

In addition to producing light and sound, the effects module may include a mechanism to change the buoyancy of the balloon, using methods which may include but are not limited to release a gas, effecting a chemical reaction, heating a gas, altering the tension or volume of the balloon. An altimeter may be incorporated or control may be by internal program, and/or external signal including RF, photonic, and acoustic. Details are discussed in my prior related disclosures.

One or more surfaces of the balloon may include an active photonic material, altering the reflectivity, diffusion, transparency, absorption, emissivity or color of the surface. Details are disclosed in my prior related disclosures but include the use of LEDs, photo-chromic materials, electronic ink, or liquid crystals.

FIG. 8 shows a preferred mesh embodiment having a balloon 200, a mesh network 1150, mesh actuator, a controller, a signal receiver, an altimeter and a power source. In operation, the mesh network 1150 is effected by means of the mesh actuator causing the volume of the balloon to change. The mesh actuator may be memory wire, a peizolinear motor, a micromotor on a spool, or any other available actuator. A resultant compression of a lighter-than-air gas in the balloon 200 will cause the balloon to decrease in buoyancy, while an expansion would increase the buoyancy. An integrated altimeter of any form including but not limited to signal reception, air pressure, ultrasonic or RF measuring or temperature may be employed to control the altitude of the balloon. One representative example employs a spatially-differentiated IR photonic signal with four domains—rise, maintain, descend and descend quickly-signal lost. The controller may program complex moves and timing. Affixed propulsion in the form of propellers or any other means may be employed as well as but not limited to all of the visual, audio and other effects disclosed in the present application.

Projector/Signal Generator Unit—Beam Direction

FIG. CX 1 presents a preferred embodiment of a beam directional system for the projector/signal generator/camera units 200 which does not require a slip ring, split transformer or other electronic power transfer to control the ‘tilt’ mirror. The generalized beam-direction system comprises a light/signal source 710 with reflector 712, a first ‘pan’ mirror 714, a second ‘tilt’ mirror 716, a first ‘pan’ motor 718 and a second ‘tilt’ motor 720. The pan motor 718 drives (shown with a belt drive) beam direction unit 722 by its rotatable pan tube 724. Rotatable in the interior of the pan tube 724 is the tilt tube 726 which is driven by tilt motor 720. Tilt mirror 716 is driven shown driven by a right angle belt drive 728 from the top of the tilt tube 726 to the tilt mirror pulley. Gearing may also be employed. In the present two-mirror embodiment the optical axis 730 is offset from the center of rotation 732.

FIG. CX 2 shows a three mirror embodiment with a centering mirror 734 which enabled the coaxial positioning of the optic 730 and rotational 732 axes.

FIG. CX 3 shows an alternative embodiment with a pivotable light source and optics module 710, 712 pivotably mounted, shown on a ball joint but may included any articulated mounting such as but not limited to gyro-pivot, flexible polymer or magnetic, in the beam direction housing 742 and with an anti-rotation mechanism employing a stationary arm 744 affixed to the outer housing 746 and a pivotable, but non-rotational, ball joint 740. The source module 710/712 is free to assume any angular position relative to the arm. The tilt drive mechanism may be collapsed into a single external rotational tube.

One advantage of the present embodiment is that a power-line affixed to the stationary arm 744 remains untwisted as a result of the non-rotation of the beam direction unit housing 710/712.

FIG. CX 4 shows an articulated, gyroscopic mount embodiment where the pan arm motor 718 rotatable attached at both ends forces the beam direction housing 742 to articulate about the central axis at a proscribed angle. The gyroscopic mount 750, 752 maintains the orientation of the beam direction housing 742. The tilt mirror 16 is driven by the tilt motor 20 also mounted on the beam direction unit 22. The pan motor may be mounted externally on the pivot arm 744.

One advantage of the present embodiment is that a power-line affixed to the housing 742 remains untwisted as a result of the non-rotation of the beam direction housing 742/710/712. Another advantage is that a full and continuous 360 degree pan and tilt may be achieved with a reduced momentum.

Audience Stage Environment—Holographic Screen

The aforementioned audience autostereoscopic unit relates to a group of technologies which I describe as ‘beam holographic’ or composed of light beams.

Building an 3D pixel which may be usefully in compact or stadium size 3D displays have been long-standing challenge. The principle attempts have relied on very high-resolution static matrices as an extension of lenticular imaging.

The present invention employs dynamic elements, singularly or part of a spare or fine matrix, and a precision control system to solve this long-standing problem.

FIG. BH1 shows the basic building element: the 3D pixel 1100. The dynamic, single-element embodiment employs a light source 1110, static or dynamic beam optics 1120, a beam scanner 1130, one or more registration elements 1142, 1146. and control electronics 1180 which may include a microprocessor, memory and a communication component. In operation, the light source 1110 is projects through the static or dynamic optics 1120 a shaped pixel which is scanned by the scanning component 1130 across the audience 1200 (see FIG. BH4). The scope and registration of the pixel 1100 may determined by receiver element 1140 or beacon element 1148.

There are many well-known projection and scanning systems. The elements shown in FIGS. 1-1F are only representative. Common methods include but are not limited to scanning and resonant optics, prisms and mirrors, acousto-optic, LCD and other solid-state beam alternating technologies, MOEMS etc. The present invention may employed any light source, projection optics and scanning method.

It may be noted that the dynamic optics 1120 may enable a specific focal distance for each pixel corresponding to the realistic, contrived, synthetic or perceived distance between the audience viewer and the imaged object pixel. The dynamic optic 1120 is representative and may include other focal distance technologies known including but not limited to variable focus mirrors, compressible lenses, electrostatic or liquid crystal lenses or active diffractive, holographic lenses, as well as innovations of the present inventor currently pending or in process.

As shown in FIG. BH5, a camera or other sensing device 1500 may be employed to acquire the location and position of each member of the audience, including the position of each of the audience member's eyes. When enabled, the visual image data presented at any moment in time may correspond to the appropriate stereographic image data—left eye image/right eye image. This embodiment may be employed with or without focal depth control. One advantage of this embodiment is that a fully visually accommodative image may be represented by four data components—red, green, blue intensities and distance. An image thus encoded by extending known “codecs” or algorithms will be less than 133% in size to the corresponding stereographic image, thus enabling cost effective storage and transmission by current media and methods.

FIG. BH1B shows an indirect scanned embodiment shown as having a second reflection scanning element 1132 which further expands the field or angle of the scan.

FIG. BH1C shows an indirect scanned embodiment shown as having a multiplicity of second reflection scanning elements 1132, 1132′, 1132′″ each which further expands the field or angle of the scan 1190, generally overlapping the others 1190′.

FIG. BH1D shows an resonant scanner 1130. Resonant technologies applied to fiber optics, fiber arrays, cantilevered mirror units, and other MOEMS configurations may be employed.

FIG. BH1E shows an solid-state scanner 1130 including but not limited to liquid crystal, acousto-optic, and other optical and prismatic methods of altering the refractive index of a medium or beam control by diffraction may be employed.

FIG. BH2 shows a perspective view of the basic elements of a single pixel.

FIG. BH3 shows a perspective view of a columnar array 1160 of single pixel 1100 arranged as a spaced-apart display 1162. When constructing a columnar array, all of the individual pixels 1100 may be tied to a single scan motor or driver 1130M, and a registration element 1142/1146. A high degree of precision may be recognized by having two registration elements 1142/46 incorporated in the top and bottom pixels 1100, 1100T.

Saccadic addition, by quickly displaying a multiplicity of intermediate (images which would be displayed in a continuous display) images, may be employed to increase the perceived resolution of the image.

FIG. BH3-N1a-c shows a series of views of a columnar array 1160 constructed using one or more SLM 1202 (spatial light modulators such as LCOS, DMD, LCD, OLED arrays), where FIG. N1a shows a top view of the SLM 1202 projecting its beam into an anamorphic beam expanding optic 1204 and exiting a fan of pixels 1190. It is understood that the horizontal fan of pixels 1190 may include a wide or narrow vertical component, representing a fan of a vertically-oriented line pixels. The lines may be slightly offset or interlaced to improve 3D resolution. FIG. N1b show another embodiment of the expansion optics 1204—which may include any known multiple path, aspheric, TIR (total internal reflection), refractive, holographic or reflective technology. FIG. N1c shows a side view of columnar array 1160 illustrating an anamorphic, multiple path, reflective embodiment.

Saccadic addition, by quickly displaying a multiplicity of intermediate (images which would be displayed in a continuous display) images, may be employed to increase the perceived resolution of the image.

FIG. BH4 shows a front perspective view of a single pixel 1100 in operation projecting 1190 a fan of light which focuses as a vertical line 1194 at or behind the most distant member of the audience 1200. Other shapes and directions may employed including oblique, complex and horizontal. The projection of multiple units may overlap, interlace or present independent images. A thin line 1194 in horizontal parallax beam holography or point of full beam holography improves the resolution of the display system by reducing the transitional state arc length—the change in position will the pixel is changing color and intensity.

FIG. BH5 shows a rear perspective view of a single pixel 1100 in operation projecting 1190 a fan of light which focuses as a vertical line 1194 at or behind the most distant member of the audience 1200.

A beam holographic display converges the concepts of phase holography and 3D optical autostereoscopy, best known as lenticular screen autostereoscopy.

Common to all 3D displays is horizontal parallax or disparity of images—the display of a unique image to each eye of the observer. When using 3D glasses, such as the active IMAX Shutter Glasses, the Polaroid polarization direction or the Disney Viewmaster, the different images are intact—either physically different as in the Viewmaster slide, overlapping but separable as in Polaroid glass and anaglyphs, or temporal distinct as in the sequentially displayed shutter glasses.

In lenticular 3D, each column of resolution of each first image is inculcated with a column of second, resulting in a precisely offset matrix which is accurately positioned behind a lenticular lens, which directs the column to the proper eye. Positioning the image, and directing the output to the proper eye is a substantial challenge.

In horizontal-parallax, beam holography, the lenticular optics is replaced by a scanning optical pixel. Registration of the beam to coordinate the scan, modulation and eye space is problematic.

One method of registration is to align each pixel 1100 with a fixed reference point. 1148′ shown in FIG. BH1. The process may be accomplished manually through a sighting aperture on the pixel or by protecting a narrow single beam from the pixel 1100. The reference point(s) 1148 may be replaced by a camera(s) 1140 which ‘looks’ for the proper illumination from the pixel. The operator at the pixel may have a portable monitor of the camera image. Alternatively, an alignment actuator on the pixel may be activated the system alignment software which adjusts each pixel until displays the proper pattern. The process may be fully automated and periodically repeated.

In order to make the process invisible to the audience, the pixel may have an IR/UV alignment source or narrow spectral notch filter. In current practical terms for an LED RGB pixel, an IR/UV LED 1142 may be added to the pixel light source elements.

Under many real life conditions, a periodic alignment process would be difficult, expensive or consume precious resources.

FIG. BH5 shows the placement of two of the receiver/camera 1140 or beacon 1148 at the lateral edges of the audience 1200. In these cases, the definition of a position which corresponds directly to the audience allows the pixel to precisely orient to the audience 1200.

In the beacon embodiment, each reference beacon 1148, 1148′, 1148′″, which may be an IR, UR or other photonic spectrum and source, is monitor by a photo-receiver 1146, part of the pixel assembly 1100, which scans with the visible beam 1190. Thus, the pixel scanning system will precisely align with the audience and derive an accurate scan period for the modulation of the light source. All of the parameters may be controlled remotely and changed on the fly. By using an invisible range of the spectrum, or a very narrow visible range, the system can continually update without disturbing the audience.

In the receiver embodiment, the reference receiver 1140 (which may be a camera) placed in about the audience 1200 acknowledges the proper alignment of each pixel and sends a signal to the pixel 1100 to register the correct position. While, this approach requires a more lengthy communications scheme, it may be implemented using the primary RGB sources—thus contributing to the economy of the system.

FIGS. BH6 & BH7 present a compact, rear projection embodiment of the present invention having a scanning pixel array 1162 reflect from a second reflection elements 1132′ and a rear projection mirror 1300 through an audience optic 1310. In the general design, this embodiment follows the principles of compact rear projection displays, except that it not essential to create a real image in the plane of the audience optic 1310, whose purpose is principally to vertical diverge the beam to allow the audience at different heights to view the same image. A horizontally oriented, fine pitch, lenticular screen or holographic optical element alternatives are often used.

The compact rear projection system approach may be applied to front and transmissive systems as well, including theatrical environments.

FIG. BH8 shows a feedback system 1400 which may be directional signals, camera, location, GPS, orientation (Polhemus Tracker units, etc) affixed to each Section 1410 of the Display Columns 1160 to communicate to the System the location and orientation of the Section

Audience Unit—Shield/Flat Panel

FIG. FL-1 is a simplified schematic side view of an LED light fixture/panel 100 provided in accordance with the present invention shown in a configuration for a drop ceiling installation having a bottom transmissive diffusing panel 2110, an intermediately positioned LED light source elements 2120 affixed to a supporting frame 2130 and a top diffuse reflective surface 2140 which may be a surface of the top panel 2150. A supporting perimeter frame 2152 is provided which may be sealed and impervious to dust and water. In operation, light 2160 from the light source elements 2120 is directed towards the top reflective diffuse surface 2140 where it is diffusively reflected towards the bottom transmissive diffusing panel 2110.

The bottom transmissive panel 2110 diffusively transmits a defined percentage of the light 2160 into the illuminated environment 2170, and reflects a defined percentage of light 2162 back towards the top reflective surface 2140. The first reflected light 2162 is again reflected from the top reflective surface 2140 and a percentage of this light 2162 is transmitted into the environment 2170. A defined percentage of first reflected light 2162 is again reflected by the bottom panel 110 towards the top reflective surface 2140 and returned to the cycle as second reflected light 2164. This cycle of transmission and reflection may continue until a substantial percentage of the light is transmitted into the environment.

The efficiency of the present invention may be further improved by affixing a reflective surface 2140′ to the bottom and other non-emissive surfaces of the light source 2130 and perimeter 2152 frames. By manufacturing a bottom transmissive panel 2110 that has a low coefficient of light absorption, preferably less than 1%, and a top reflective diffuse surface 2140 with a high reflectivity, preferably greater than 97%, overall efficiencies of greater than 90% may be achieved.

FIG. FL-2 is a simplified schematic side view a light-redirecting optical element 2126 adjacent to the light source elements 2120 enabling a proscribed portion of the emitted light to fill in underneath the light emitting element 2120 to produce an even illumination or a defined pattern to be presented to an external observer. This pattern may be of any shape or form, including but not limited to a linear, cross-hatched or diagonal array, one or more points, star, circles disks, ellipses, an edge weighted or center weighted gradient, or a fully uniform presentation.

The arrangement of the light emitting elements 2120 and the re-directing elements 2126 may be in any pattern including but not limited to linear, hatched or checkerboard arrays. Transparent, diffusive or reflective struts 2128 may be employed to maintain an even spacing of the panels and elements.

One advantage of the present embodiment is that a rigid structure may be easily constructed by employing a stiff optical polymer, structural/optic composite or sandwich for the re-directing matrix 2126, thus reducing the thickness, cost and weight of the transmissive and reflective panels 2110, 2140.

The embodiments of the invention particularly disclosed and described herein above is presented merely as examples of the invention. Other embodiments, forms and modifications of the invention coming within the proper scope and spirit of the appended claims will, of course, readily suggest themselves to those skilled in the art.

1. A spatial signal generator and audience unit receiver system further comprising:
a) a control board having means to transmit a series of commands to a projector-signal generator,
b) said projector having means to receive a said series of commands from said control board and having means to project at least one directional signal to at least one of a plurality of audience unit receivers,
c) said at least one of a plurality of audience unit receivers having means to receive said at least one directional signal and emit a designated response.

2. A projector and audience unit receiver system as specified in claim 1 wherein said audience unit receiver means for emitting a designated response further includes at least one light and means for powering said light.

3. A projector and audience unit receiver system as specified in claim 1 wherein said audience unit receiver means for emitting a designated response further includes at least one audio speaker and means for powering said speaker.

4. A projector and audience unit receiver system as specified in claim 1 wherein said projector further includes means for automatic spatial registration.

5. An autostereoscopic performance effects systems further comprising:
a) a control board having means to transmit a series of commands to a projector/signal generator,
b) said projector having means to receive said series of commands from said control board and having means to project at least one directional signal to at least one of a plurality of audience unit receivers,
c) said at least one of a plurality of audience unit receiver having means to receive said at least one directional signal and emit a designated response, said audience unit displaying at least one pixel of autostereoscopic pattern.

6. An autostereoscopic performance effects systems in accordance with claim 6 further comprising:
a) a control board having means to transmit a series of commands to a projector,
b) said projector having means to receive said series of commands from said control board and having means to project at least one directional signal to at least one of a plurality of audience unit receivers,
c) said at least of a plurality of audience unit receiver having means to receive said at least one directional signal and emit a designated response.
d) said audience unit displaying a at least one pixel of autostereoscopic pattern and wherein said at least one of a plurality of audience unit receivers further includes means to shift said autostereoscopic pattern in relation to the orientation of the at least one of a plurality of audience unit receivers.

7. A performance display systems in accordance with claim 1 wherein said projector means further include means to mount upon a track having an optical communications means.

8. A performance display systems in accordance with claim 1 wherein said projector means further include means to increase the perceived resolution by saccadic patterns.

9. A beam holographic performance display system comprising:
a) a control means transmitting a series of commands to a projector matrix,
b) said projector matrix having means to receive said series of commands from said control means and having means to project at least one directional image to at least one of a plurality of audience members.

10. A beam holographic performance display system in accordance with claim 9 further comprising said projector matrix means to increase the perceived resolution by saccadic patterns.

11. A performance display system accordance with claim 9 wherein said projector means further include transform means to transform an X-Y array into a series of horizontal arrays visible through a reduced number of apertures.

12. A projector and audience unit receiver system in accordance with claim 1, further comprising a multiplicity of data projectors controlled by a control means for the precise registration and timing of said multiplicity of projectors-signal generators.

13. A projector and audience unit receiver system in accordance with claim 1, further comprising an audience display unit having at least one orientation sensor means for receiving a signal for an orientation beacon

14. A projector and audience unit receiver system in accordance with claim 1, further comprising an audience display unit having at least one motion sensor means, and further having at least one programmed function which detects when said audience display unit has been static for a given period of time and enables the display of visual effects with saccadic timing.

15. A projector and audience unit receiver system in accordance with claim 1, wherein said individual audience receiver units each have has a plurality of visual pixels controlled by a single data stream.

16. An autostereoscopic projector and audience unit receiver system in accordance with claim 5, further comprising an audience display unit having at least one orientation sensor means for receiving a signal for an rientation beacon.

17. An autostereoscopic performance effects systems in accordance with claim 5 further comprising:
a) a control board having means to transmit a series of commands to a projector,
b) said projector having means to receive said series of commands from said control board and having means to project at least one directional signal to at least one of a plurality of audience unit receivers,
c) said at least of a plurality of audience unit receiver having means to receive said atleast one directional signal and emit a designated response, said audience unitdisplaying at least one pixel of autostereoscopic pattern, and
d) further comprising an audience display unit having an integrated Autoview optics.

18. A audience unit system in accordance with claim 1, wherein said individual audience receiver units respond to the audience member's motion relative to a proscribed motion encoded or transmitted.
